(19) United States
(12) Patent Application Publication
(10) Pub. No.: US 2025/0264593 A1
(43) Pub. Date: Aug. 21, 2025

(54) OBJECT DETERMINATION APPARATUS AND OBJECT DETERMINATION METHOD

(71) Applicant: Panasonic Automotive Systems Co., Ltd., Kanagawa (JP)

(72) Inventors: Yunyun CAO, Tokyo (JP); Yuichi ISHIKAWA, Hyogo (JP); Hirohito MUKAI, Tokyo (JP); Osamu SHIBATA, Hyogo (JP); Shuji AKAMATSU, Kanagawa (JP); Shunsuke TSUJIOKA, Nara (JP)

(21) Appl. No.: 19/056,377

(22) Filed: Feb. 18, 2025

(30) Foreign Application Priority Data
Feb. 19, 2024 (JP) 2024-023146
Nov. 15, 2024 (JP) 2024-199481

(51) Int. Cl. G01S 7/527; G01S 15/04

(52) U.S. Cl. CPC G01S 7/527; G01S 15/04

(57) ABSTRACT

An object determination apparatus includes: a calculator that calculates a difference in time of flight of a plurality of ultrasonic waves reflected by an object and received by a plurality of sonar apparatuses, or a difference in distance corresponding to the time of flight; and a determiner that determines a type of the object based on the difference.

### TECHNICAL FIELD

The present disclosure relates to an object determination apparatus and an object determination method.

### BACKGROUND ART

In an existing automatic brake system, waveform of a reflected wave is normalized according to attenuation characteristic information of an ultrasonic wave based on with the distance from a vehicle to an object that reflects the ultrasonic wave, and it is determined that there is an object when the reflection intensity is equal to or greater than a predetermined threshold. In this case, it is possible to detect walls or the like other than curbs, by setting the threshold equal to or greater than the intensity of a reflection wave from a curb where it is not necessary to activate the brake (see PTL 1).

### CITATION LIST

### Patent Literature

### PTL 1

Japanese Patent Application Laid-Open No. 2022-142252

### SUMMARY OF INVENTION

### Technical Problem

However, the intensity of the reflected wave is weak in the case of an object with a complex shape, such as a human. For this reason, there is a possibility that the intensity of the reflection wave is equal to or less than the threshold value also in the case of such an object, and the brake is not activated, resulting in a collision of the vehicle with the object.

On the other hand, when the threshold is set less than the intensity of the reflection wave from the curb, the brake is activated for a person, and a collision with a person can be avoided, but the brake is also activated for the curb.

A non-limiting embodiment of the present disclosure contributes to providing a determination apparatus and a determination method capable of accurately determining an object.

### Solution to Problem

Accordingly, one aspect of an object determination apparatus according to the present disclosure includes: a calculator that calculates the differences in Time of Flight (TOF) or the distances corresponding to the TOF of a plurality of ultrasonic waves reflected by an object and received by a plurality of sonar apparatuses in one transmission period, or with respect to a transmission wave of a certain sonar apparatus; and a determiner that determines a type of the object based on the difference.

Further, one aspect of an object determination method according to the present disclosure includes: calculating the differences in Time of Flight (TOF) or the distances corresponding to the TOF of a plurality of ultrasonic waves reflected by an object and received by a plurality of sonar apparatuses; and determining a type of the object based on the difference.

### Advantageous Effects of Invention

According to the present disclosure, it is possible to accurately determine the type of an object.

### BRIEF DESCRIPTION OF DRAWINGS

FIG. 1 illustrates brake control thresholds in a current sonar system;

FIG. 2 illustrates installation positions of sonar apparatuses;

FIG. 3 illustrates reflection of ultrasound by a pedestrian;

FIG. 4A illustrates an example of the dimensions of a pedestrian;

FIG. 4B illustrates a positional relationship between a pedestrian and a vehicle;

FIG. 5A illustrates a difference in the X-direction of reflection points;

FIG. 5B illustrates the influence of the difference in the X-direction of the reflection points;

FIG. 6A illustrates a difference in the Y-direction of reflection points;

FIG. 6B illustrates the influence of the difference in the Y-direction of the reflection points;

FIG. 7A illustrates a difference in the Z-direction of reflection points;

FIG. 7B illustrates the influence of the difference in the Z-direction of the reflection points;

FIG. 8A illustrates reflection of ultrasound by a pedestrian;

FIG. 8B illustrates a difference value of TOF that changes over time;

FIG. 9 illustrates a fluctuation in a difference value of TOF with respect to a pedestrian;

FIG. 10 illustrates reflection of ultrasonic waves by a curb;

FIG. 11A illustrates a positional relationship between a vehicle and a curb;

FIG. 11B illustrates a positional relationship between a vehicle and a curb;

FIG. 11C illustrates the maximum value of the difference in TOF with respect to the curb;

FIG. 12A illustrates the transmission period of each sonar apparatus;

FIG. 12B illustrates a fluctuation in a difference value of TOF with respect to a curb;

FIG. 13 illustrates a positional relationship between a pole and a vehicle;

FIG. 14A illustrates a positional relationship between a pole and a vehicle;

FIG. 14B illustrates a positional relationship between a pole and a vehicle;

FIG. 14C illustrates the maximum value of the difference in TOF with respect to the pole;

FIG. 15 illustrates a fluctuation in a difference value of TOF with respect to a pole;

FIG. 16 illustrates an exemplary configuration of an object determination apparatus according to Embodiment 1;

FIG. 17 is a flowchart illustrating an example of object determination processing according to Embodiment 1;

FIG. 18 illustrates an exemplary configuration of an object determination apparatus according to Embodiment 2;

FIG. 19 is a flowchart illustrating an example of object determination processing according to Embodiment 2;

FIG. 20 illustrates an exemplary configuration of an object determination apparatus according to Embodiment 3;

FIG. 21 is a flowchart illustrating an example of object determination processing according to Embodiment 3;

FIG. 22 illustrates reflection of ultrasonic waves by a pedestrian;

FIG. 23 illustrates reflection of ultrasound by a pedestrian;

FIG. 24 illustrates an example of data used for determining whether an object is a pedestrian;

FIG. 25 illustrates a method for calculating a distance estimation value between a pedestrian and a sonar apparatus used for determining whether an object is a pedestrian;

FIG. 26 illustrates a calculation result of a difference between a measurement distance and an estimation distance for a moving object;

FIG. 27 illustrates a fluctuation in a difference value of TOF with respect to a stationary doll;

FIG. 28 illustrates an exemplary configuration of an object determination apparatus according to Embodiment 4; and

FIG. 29 is a flowchart illustrating an example of object determination processing according to Embodiment 4.

### DESCRIPTION OF EMBODIMENTS

Hereinafter, embodiments of the present disclosure will be described with reference to the drawings. Note that each of the embodiments described below shows a specific example of the present disclosure. Therefore, each component, the arrangement position and the connection form of each component, as well as the steps and the order of the steps illustrated in the following embodiments are examples and are not intended to limit the present disclosure. Furthermore, among the components in the following embodiments, those which are not recited in the independent claims are described as arbitrary components.

Additionally, each figure is a schematic figure and is not necessarily a strict illustration. Note that, in the drawings, substantially the same components are denoted by the same reference numerals, and redundant descriptions thereof will be omitted or simplified.

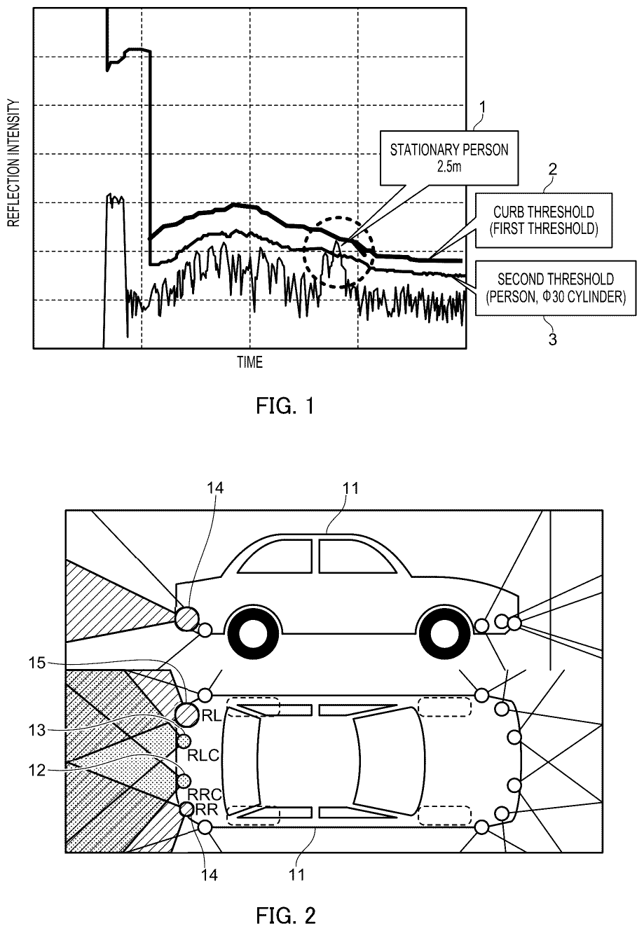

To begin with, the current state of sonar systems will be described. As shown in FIG. 1, Autonomous Emergency Braking is basically desired to operate against tall objects. At present, a threshold corresponding to the intensity of an ultrasonic wave reflected by a curb is set, and the brake is activated when the reflection intensity of the ultrasonic wave is equal to or greater than this threshold. For example, the brake does not operate for a step of 10 cm or 15 cm or less, but operates for a step higher than this.

However, there are objects such as a cylinder with a diameter of approximately $30 mm or a pedestrian, which are tall but have a reflection intensity below the threshold. In this case, if a threshold (second threshold) smaller than the threshold (first threshold) for the curb is set to avoid collision with a cylinder or a pedestrian, the brake will be activated for the curb.

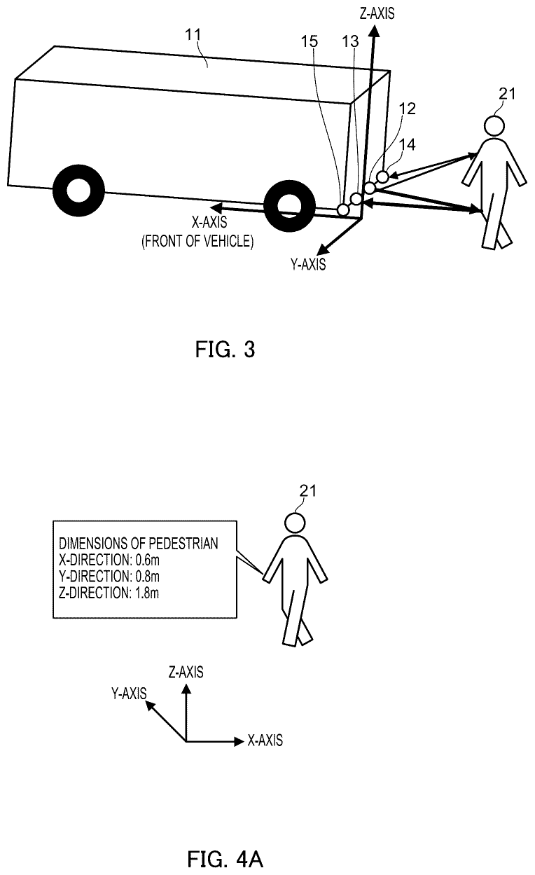

As illustrated in FIG. 2, sonar apparatuses are provided in the front and rear of vehicle 11. Each of the sonar apparatuses includes a Time Of Flight (TOF) sensor that transmits ultrasonic waves, receives reflected waves reflected by an object, and measures the distance to the object based on the time of flight of the ultrasonic waves.

In the present embodiment, sonar apparatus 12 (hereinafter referred to as RRC) at the rear right center of vehicle 11, sonar apparatus 13 (hereinafter referred to as RLC) at the rear left center, sonar apparatus 14 (hereinafter referred to as RR) at the rear right, and sonar apparatus 15 (hereinafter referred to as RL) at the rear left will be described as examples.

For example, the information on the TOF of the ultrasound is calculated in each of the following cases.
(a-1) A case where the ultrasonic wave transmitted by RRC 12 is received by RRC 12, or RLC 13 and RR 14. Further, a case where the wave is received by RL 15 may be included.
(a-2) A case where the ultrasonic wave transmitted by RLC 13 is received by RLC 13, or by RRC 12 and RL 15. Further, a case where RR 14 receives the wave may be included.
(a-3) A case where the ultrasound transmitted by RR 14 and RL 15 is received by RR 14, RL 15, RRC 12, and RLC 13.

Further, the coordinates information of the object is calculated by triangulation in each of the following cases.
(b-1) A case where the ultrasound transmitted by RR 14 is received by RR 14 and RRC 12 (S0 coordinate), and a case where the ultrasound transmitted by RL 15 is received by RR 15 and RLC 13 (S5 coordinate).
(b-2) A case where the ultrasound transmitted by RRC 12 is received by both RRC 12 and RR 14 (S1 coordinate), and a case where the ultrasound transmitted by RRC 12 is received by RLC 13 (S2 coordinate).
(b-3) A case where the ultrasound transmitted by RLC 13 is received by RLC 13 and RRC 12 (S3 coordinates), and a case where the ultrasound transmitted by RLC 13 is received by RL 15 (S4 coordinates).

When the TOF of the ultrasound calculated in this manner is analyzed in a case where a person is the object, it is known that the TOF varies in each of cases (a-1) to (a-3) even for the same person. Further, it is also understood that the coordinates of S0, S1, S4, and S5 vary in the width direction of vehicle 11. For this reason, in the case of performing each measurement of (a-1) to (a-3) and (b-1) to (b-3), it is presumed that the position of the reflection point at which the ultrasound is reflected is likely to be different due to the complex shape of a person.

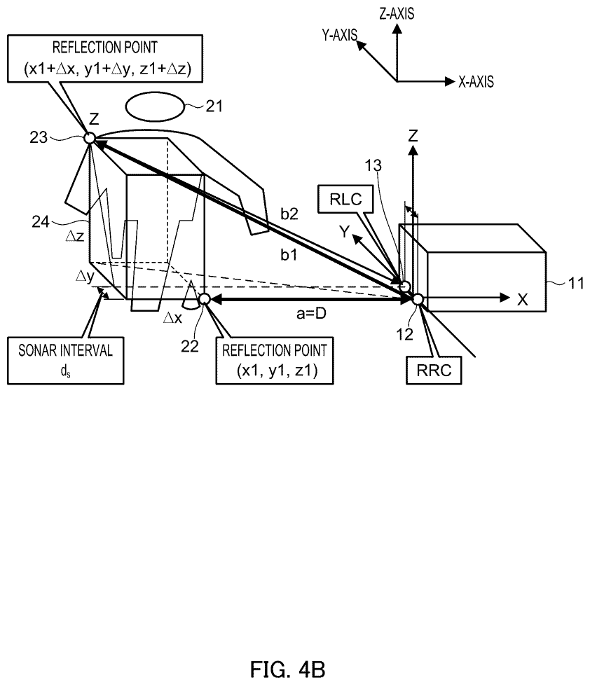

This point will be further considered in detail. As illustrated in FIG. 3, the reflection point of pedestrian 21 varies depending on the sonar apparatus that transmits the ultrasonic wave, the sonar apparatus that receives the reflected wave, the position of pedestrian 21, or the posture of pedestrian 21. Further, since both vehicle 11 and pedestrian 21 move, it is extremely difficult to determine whether the object is pedestrian 21 or not based on the TOF of the ultrasonic wave received by one sonar apparatus. Further, the intensity of the reflected wave from pedestrian 21 is weak, and the shape of pedestrian 21 is also complex, making it even more difficult to detect pedestrian 21.

Accordingly, the technique of the present disclosure focuses on the following points. Here, in each transmission period in which TOF is measured, there is one sonar apparatus that transmits the ultrasonic wave, and there are a plurality of sonar apparatuses that receive the ultrasonic wave. Further, in the following, the time of flight or the flight distance (distance to the object) of a sound wave to the object measured by the TOF sensor of the sonar apparatus will be represented by TOF.

Reflection points from a human body are different in almost all the cases, and when the TOF of the ultrasonic wave received by a first sonar apparatus is defined as TOFₛₒₙₐᵣ₁ and the TOF of the ultrasonic wave received by a second sonar apparatus is defined as TOFₛₒₙₐᵣ₂, it is understood that following relation a and relation b are present.
a. Two TOFs are different.

$$diff = {TOF}_{sonar 1} - {TOF}_{sonar 2} \neq 0$$

b. The difference between the two TOFs is within a certain range.

$$\vert {TOF}_{sonar 1} - {TOF}_{sonar 2} \vert < threshold$$

Note that threshold is determined by the distance between pedestrian 21 and vehicle 11, the positional relationship between the sonar apparatus that transmits the wave and the sonar apparatus that receives the wave, and the size of pedestrian 21.

That such TOF difference value is smaller than a predetermined threshold is the first key point in the technology of the present disclosure.

Further, since vehicle 11 and pedestrian 21 move, the reflection surface is not stable. For this reason, the TOF detected by each sonar apparatus varies randomly within a predetermined range over time. This is the second key point in the technology of the present disclosure.

Further, the geometric shape of pedestrian 21 is complicated, and it is common that the reflection point of the ultrasonic wave is different between a case where the ultrasonic wave transmitted by a certain sonar apparatus is received by this certain sonar apparatus and a case where the ultrasonic wave transmitted by a certain sonar apparatus is received by another sonar apparatus.

In addition, in a case where the object is pedestrian 21, the reflection part (head, shoulder, abdomen, thigh, knee, foot, and the like) changes depending on the distance to pedestrian 21 and the posture of pedestrian 21. For example, as shown in FIG. 3, when pedestrian 21 walks in the Y-direction, the changes in the distances of the reflection points in the X-, Y-, and Z-directions caused by the movement of limbs are approximately 0.6 m, 0.9 m, and 1.8 m, respectively. The difference in the TOF of the ultrasonic wave between different sonar apparatuses randomly changes within a predetermined range due to such changes of the reflection points in the X-, Y-, and Z-directions.

Hereinafter, two sonar apparatuses, RRC 12 and RLC 13, will be described as examples, and the influence of differences in the X-, Y-, and Z-directions of reflection points on the TOF will be described in detail.

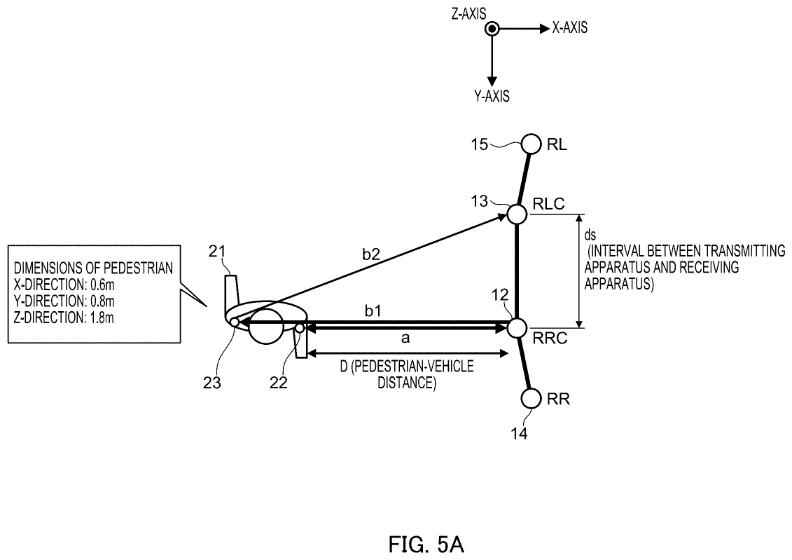

As illustrated in FIG. 4A, the dimensions of pedestrian 21 are 0.6 meters in the width direction (X-direction), 0.8 meters in the front-back direction (Y-direction), and 1.8 meters in the height direction (Z-direction)

Further, in order to understand the equations for distances b1 and b2 described below, the positional relationship between reflection point 22 and reflection point 23 will be described assuming that pedestrian 21 is cube 24, as illustrated in FIG. 4B. Here, difference diff in the TOF of the ultrasonic wave between RRC 12 and RLC 13 is represented as diff=TOF_{RLC}−TOF_{RRC}, where TOF_{RRC} is the TOF of the ultrasonic wave received by RRC 12, and TOF_{RLC} is the TOF of the ultrasonic wave received by RLC 13.

Here, the maximum value of difference diff in TOF between two reflection points 22 and 23, whose coordinates differ by Δx, Δy, and Δz in the X-, Y-, and Z-directions, respectively, is determined by the distance between pedestrian 21 and vehicle 11, dimensions Δx, Δy, and Δz of pedestrian 21 in the X-, Y-, and Z-directions, and distance dₛ between RRC 12 and RLC 13. Dimensions Δx, Δy, and Δz correspond to the width, thickness, and height of pedestrian 21, respectively.

Hereinafter, TOF_{RRC} and TOF_{RLC} represent values obtained by dividing by 2 the distance corresponding to the time it takes for the ultrasonic wave transmitted by RRC 12 to be reflected by pedestrian 21 and received by RRC 12 and RLC 13.

First, TOF_{RRC} is minimized when the ultrasonic wave is reflected at reflection point 22, which is the closest to vehicle 11. For example, when a is the distance from RRC 12 to reflection point 22 and D is the distance from vehicle 11 to pedestrian 21, min TOF_{RRC}=a=D.

Further, the maximum value of TOF_{RLC} is represented as follows:

$$max {TOF}_{RLC} = \frac{b 1 + b 2}{2} .$$

Here, b1 and b2 are represented as follows:

$$b 1 = \sqrt{{( D + Δ x )}^{2} + Δ {z}^{2} + Δ {y}^{2}} ; and$$

$$b 2 = \sqrt{{( D + Δ x )}^{2} + Δ {z}^{2} + {( Δ y - {d}_{s} )}^{2}} .$$

Accordingly, the maximum value of TOF difference diff at reflection points 22 and 23 is as follows:

$$max ( diff ) = \frac{\begin{matrix}\sqrt{{( D + Δ x )}^{2} + Δ {z}^{2} + Δ {y}^{2}} + \\ \sqrt{{( D + Δ x )}^{2} + Δ {z}^{2} + {( Δ y - {d}_{s} )}^{2}}\end{matrix}}{2} - D \qquad ( Equation 1 )$$

Further, when the equation of the maximum value of difference diff is partially differentiated with respect to Δx, Δy, and Δz, the following equations are obtained:

$$\frac{\partial ( max ( diff ) )}{Δ x} = \frac{D + Δ x}{2} * \frac{1}{{b}_{1}} + \frac{D + Δ x}{2} * \frac{1}{{b}_{2}}$$

$$\frac{\partial ( max ( diff ) )}{Δ y} = \frac{Δ y}{2} * \frac{1}{{b}_{1}} + \frac{\vert Δ y - {d}_{s} \vert}{2} * \frac{1}{{b}_{2}}$$

$$\frac{\partial ( max ( diff ) )}{Δ z} = \frac{Δ z}{2} * \frac{1}{{b}_{1}} + \frac{Δ z}{2} * \frac{1}{{b}_{2}} .$$

From the results of these partial differentials, the influence on the maximum value of difference diff is the largest for Δx, and the influence is equal between Δy and Δz. In a case where the object is pedestrian 21, Δz corresponding to the height of pedestrian 21 is larger than Δy corresponding to the thickness of pedestrian 21, and thus, the influence on the maximum value of difference diff is greatest in the order of Δx, Δz, and Δy.

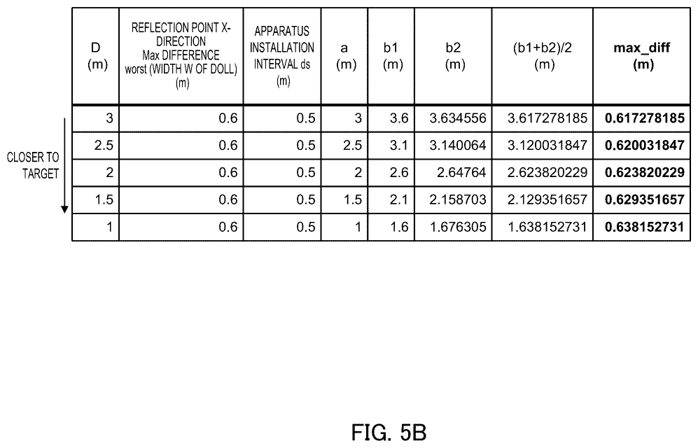

Next, the influence of the positional difference of the reflection point in the X-direction when detecting pedestrian 21 with the dimensions shown in FIG. 5A will be described. Here, the dimension of pedestrian 21 in the width direction (X-direction) is 0.6 m, the dimension in the front-back direction (Y-direction) is 0.8 m (corresponding to a case where the hands and legs are extended), and the dimension in the height direction (Z-direction) is 1.8 m.

First, TOF_{RRC} is minimized when the ultrasonic wave is reflected at reflection point 22, which is the closest to vehicle 11. For example, min TOF_{RRC}=a=D.

Further, the maximum value of TOF_{RLC} is represented as follows. Here, W is the width of pedestrian 21, and corresponds to Δx described above.

$$max {TOF}_{RLC} = \frac{b 1 + b 2}{2} = \frac{a + W + \sqrt{{d}_{s}^{2} + {( a + W )}^{2}}}{2} = \frac{D + W + \sqrt{{d}_{s}^{2} + {( D + W )}^{2}}}{2}$$

Accordingly, the maximum value of difference diff due to the position difference in the X-direction of reflection points 22 and 23 is as follows:

$$max ( diff ) = \frac{D + W + \sqrt{{d}_{s}^{2} + {( D + W )}^{2}}}{2} - D .$$

FIG. 5B illustrates the maximum value (max_diff) of difference diff that varies according to distance D from vehicle 11 to pedestrian 21. The maximum value of difference diff is a large value, and the position difference between reflection points 22 and 23 in the X-direction is substantially reflected in the maximum value of difference diff. Note that the actual distance between reflection points 22 and 23 is often smaller than width W of pedestrian 21.

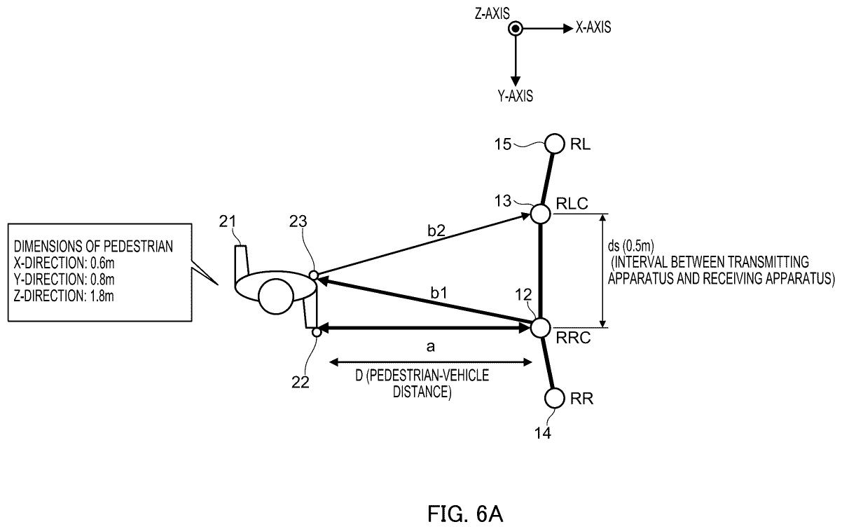

Next, the influence of the positional difference of the reflection point in the Y-direction when detecting pedestrian 21 with the dimensions shown in FIG. 6A will be described. Here, the dimension of pedestrian 21 in the width direction (X-direction) is 0.6 m, the dimension in the front-back direction (Y-direction) is 0.8 m, and the dimension in the height direction (Z-direction) is 1.8 m.

First, TOF_{RRC} is minimized when the ultrasonic wave is reflected at reflection point 22, which is the closest to vehicle 11. For example, min TOF_{RRC}=a=D.

Further, the maximum value of TOF_{RLC} is represented as follows. Here, T is the thickness of pedestrian 21, and corresponds to Δy described above.

$$max {TOF}_{RLC} = \frac{b 1 + b 2}{2} = \frac{\sqrt{{D}^{2} + {T}^{2}} + \sqrt{{D}^{2} + {( {d}_{s} - T )}^{2}}}{2}$$

Accordingly, the maximum value of difference diff due to the difference in the Y-direction positions of reflection points 22 and 23 is as follows:

$$max ( diff ) = \frac{\sqrt{{D}^{2} + {T}^{2}} + \sqrt{{D}^{2} + {( {d}_{s} - T )}^{2}}}{2} - D .$$

FIG. 6B illustrates the maximum value (max_diff) of difference diff that varies according to distance D from vehicle 11 to pedestrian 21. The influence of the positional differences in the Y-direction at reflection points 22 and 23 varies depending on distance D between pedestrian 21 and vehicle 11, with the influence increasing as the distance decreases.

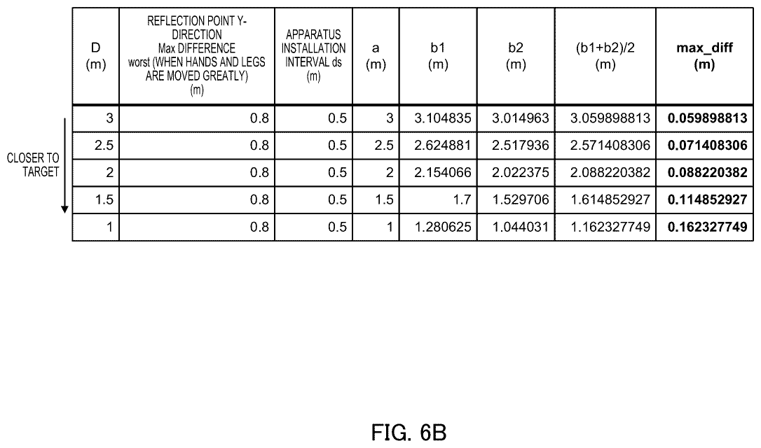

Next, the influence of the positional difference in the Z-direction of the reflection point when detecting pedestrian 21 having the dimensions shown in FIG. 7A will be described. Here, the dimension of the pedestrian in the width direction (X-direction) is 0.6 m, the dimension in the front-back direction (Y-direction) is 0.8 m, and the dimension in the height direction (Z-direction) is 1.8 m.

First, TOF_{RRC} is minimized when the ultrasonic wave is reflected at reflection point 22, which is the closest to vehicle 11. For example, min TOF_{RRC}=a=D.

Further, the maximum value of TOF_{RLC} is represented as follows. Here, H is the height of pedestrian 21, and corresponds to Δz described above. Further, dₛ is the distance between RRC 12 and RLC 13, and hₛ is the height at which RRC 12 and RLC 13 are installed.

$$max {TOF}_{RLC} = \frac{b 1 + b 2}{2} = \frac{\sqrt{{D}^{2} + {( H - {h}_{s} )}^{2}} + \sqrt{{D}^{2} + {( H - {h}_{s} )}^{2} + {d}_{s}^{2}}}{2}$$

Accordingly, the maximum value of difference diff due to the positional difference in the Z-direction of reflection points 22 and 23 is as follows:

$$max ( diff ) = \frac{\sqrt{{D}^{2} + {( H - {h}_{s} )}^{2}} + \sqrt{{D}^{2} + {( H - {h}_{s} )}^{2} + {d}_{s}^{2}}}{2} - D .$$

FIG. 7B illustrates the maximum value (max_diff) of difference diff that varies according to distance D from vehicle 11 to pedestrian 21. The influence of the positional difference in the Z-direction between reflection points 22 and 23 varies depending on distance D between pedestrian 21 and vehicle 11, and the closer the distance, the greater the influence.

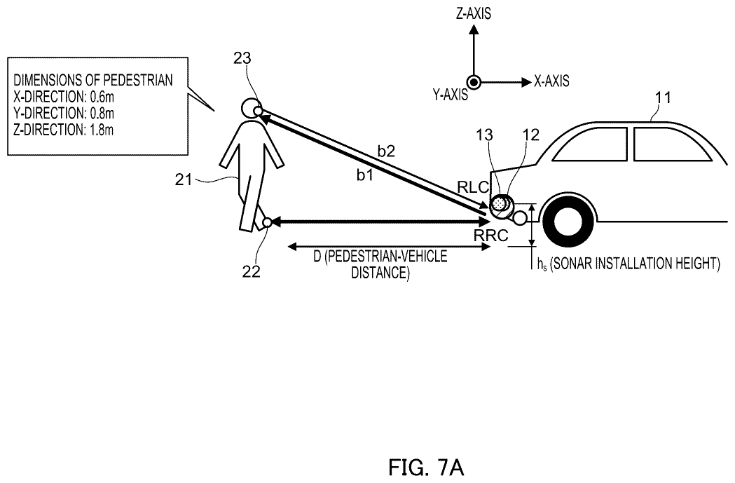

Next, the temporal fluctuation of difference diff in the TOF of the ultrasound will be described. As illustrated in FIG. 8A, a case where pedestrian 21′ is behind vehicle 11 will be considered.

Further, as indicated by the dotted line, the ultrasonic wave transmitted by RR 14 is reflected at reflection point 26 on the right elbow of pedestrian 21′, and the reflected wave is received by RRC 12. Height h₁ of the reflection point on the right elbow is 1.1 m.

Further, it is assumed that the ultrasonic wave transmitted by RRC 12 in another transmission frame is reflected at reflection point 27 on the right thigh of pedestrian 21′, and the reflection wave is received by RLC 13. Height h₂ of the reflection point on the right thigh is 0.7 m.

Further, the interval between RLC 13 and RL 15, and the interval between RRC 12 and RR 14 are 0.4 m, the interval between RRC 12 and RLC 13 is 0.5 m, the installation heights of RR 14 and RL 15 are 0.5 m, the installation heights of RRC 12 and RLC 13 are 0.55 m, and the differences Δx, Δy, and Δz in the X-, Y-, and Z-directions of two reflection points 26 and 27 are 0 m, 0.2 m, and 0.4 m, respectively.

In this case, TOF_{RRC} of the ultrasonic wave received by RRC 12 and TOF_{RLC} of the ultrasonic wave received by RLC 13 are represented by the following equations, which are the same as in aforementioned Equation 1:

$$\begin{matrix}{TOF}_{RLC} = \frac{{a}_{1} + {a}_{2}}{2} \\ = \frac{( \begin{matrix}\sqrt{{D}^{2} + {( {d}_{s 1} + \frac{{d}_{s 2}}{2} )}^{2} + {( {h}_{1} - {h}_{s 1} )}^{2}} + \\ \sqrt{{D}^{2} + {( \frac{{d}_{s 2}}{2} )}^{2} + {( {h}_{1} - {h}_{s 2} )}^{2}}\end{matrix} )}{2} \\ = \frac{\sqrt{{D}^{2} + 0365} + \sqrt{{D}^{2} + 04225}}{2}\end{matrix} \\ \begin{matrix}{TOF}_{RRC} = \frac{{b}_{1} + {b}_{2}}{2} \\ = \frac{( \begin{matrix}\sqrt{{D}^{2} + {( {d}_{s 1} + \frac{{d}_{s 2}}{2} )}^{2} + {( {h}_{2} - {h}_{s 1} )}^{2}} + \\ \sqrt{{D}^{2} + {( \frac{{d}_{s 2}}{2} )}^{2} + {( {h}_{2} - {h}_{s 2} )}^{2}}\end{matrix} )}{2} \\ = \frac{\sqrt{{D}^{2} + 04625} + \sqrt{{D}^{2} + 0085}}{2}\end{matrix}$$

FIG. 8B illustrates the difference value of TOF (TOF_{RLC}−TOF_{RRC}) that varies according to distance D from vehicle 11 to pedestrian 21′. It is understood that the difference value of TOF is small, and the difference value of TOF fluctuates as vehicle 11 approaches pedestrian 21′ and distance D decreases over time.

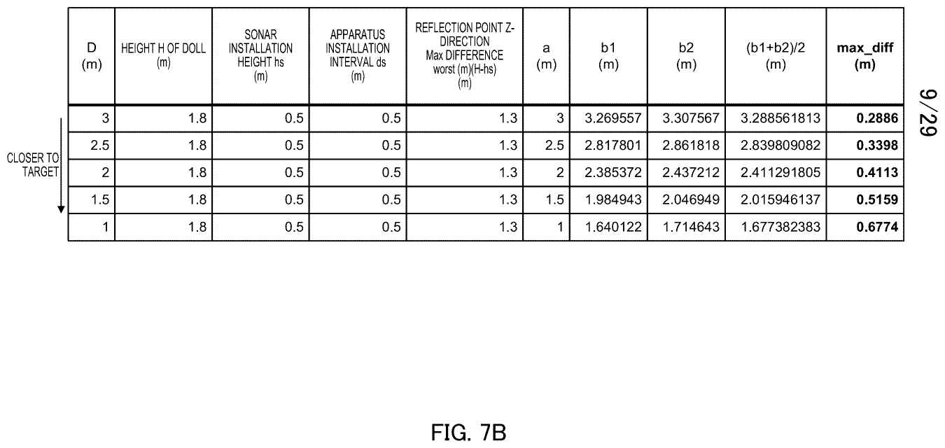

FIG. 9 illustrates a graph of the temporal change in the difference of TOF. The transmission is performed, for example, in the order of RRC 12, RLC 13, and RR 14/RL 15 at a period of 50 ms, and after simultaneous transmission from both RR 14 and RL 15 is performed, the transmission from RRC 12 is performed again. RR 14/RL 15 or RR/RL means that two sonar apparatuses transmit simultaneously in one transmission period.

In each transmission frame of an ultrasound as described above, the difference value of TOF increases as distance D decreases according to above-described Equation 1, but is smaller than a predetermined threshold. Further, due to the irregularity in the shape of pedestrian 21, the reflection point changes randomly, causing the difference value of the TOF to fluctuate within a predetermined range over time.

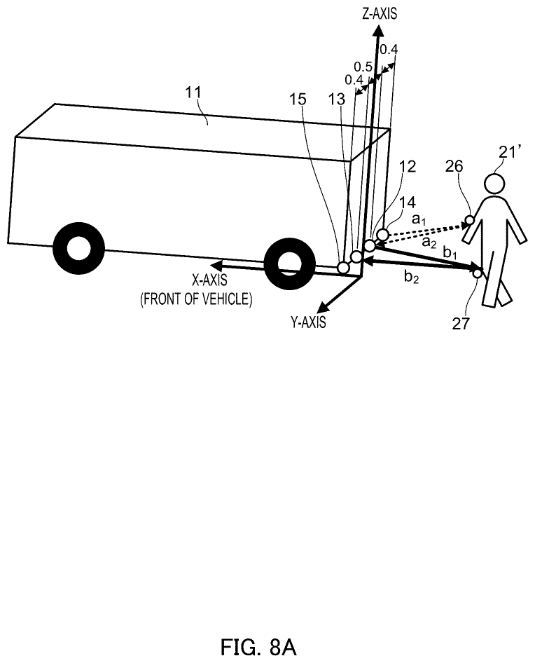

Next, a difference of TOF in a case where the ultrasonic wave is reflected by a curb will be described. As illustrated in FIG. 10, the reflection by curb 31 is basically a reflection by a plane, and in a case where the reflection surface is parallel to a line connecting the two sonar apparatuses, the coordinates in the X-direction of the two reflection points are the same (Δx=0).

Further, the first wave received by the sonar apparatus is a reflection wave that reaches the sonar apparatus via the shortest route, and since the height of curb 31 is less than 0.2 m, the coordinates of the two reflection points in the Z-direction are also substantially the same (Δz=0).

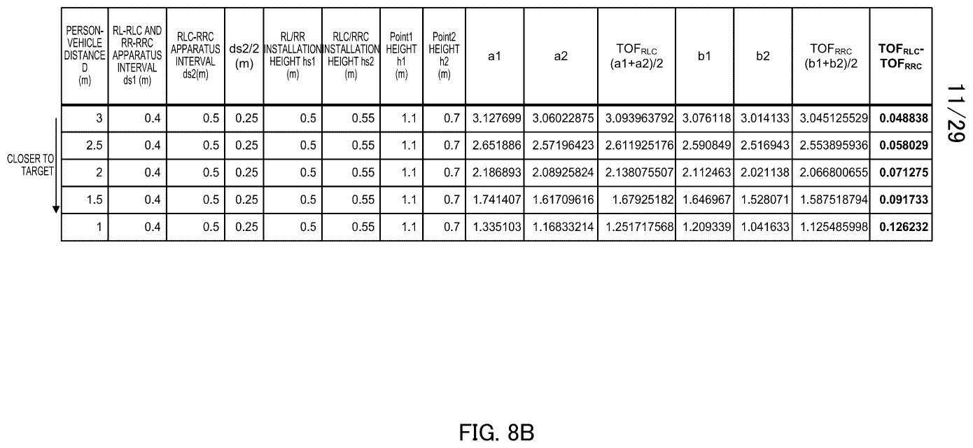

Here, as illustrated in FIGS. 11A and 11B, when the TOF of the ultrasonic wave received by RRC 12 is defined as TOF_{RRC} and the TOF of the ultrasonic wave received by RLC 13 is defined as TOF_{RLC}, diff=TOF_{RLC}−TOF_{RRC}.

As described above, in the case of curb 31, the reflector is a surface, and when curb 31 is perpendicular to the vehicle moving direction, the differences Δx and Δz between two reflection points 32 and 33 in the X-direction and the Z-direction are substantially 0, and thus, Δx=Δz=0.

Further, since the first wave received by the sonar apparatus is a reflection wave of the shortest route, Δy is ½ of the distance between RRC 12 and RLC 13.

$$Δ y = {d}_{s} / 2$$

First, TOF_{RRC} is minimized when the ultrasonic wave is reflected at reflection point 32, which is the closest to vehicle 11. For example, when “a” is the distance from RRC 12 to reflection point 32 and D is the distance from vehicle 11 to curb 31, min TOF_{RRC}=a=D.

Further, the maximum value of TOF_{RLC} is represented as follows:

$$max {TOF}_{RLC} = \frac{b 1 + b 2}{2} \\ b 1 = b 2 = \sqrt{{D}^{2} + Δ {y}^{2}} = \sqrt{{D}^{2} + {( \frac{{d}_{s}}{2} )}^{2}}$$

Accordingly, the maximum value of difference diff due to the positional difference in the Y-direction of reflection points 32 and 33 is as follows:

$$max ( diff ) = \sqrt{{D}^{2} + {( \frac{{d}_{s}}{2} )}^{2}} - D . \qquad ( Equation 2 )$$

FIG. 11C illustrates the maximum value (max_diff) of difference diff that varies according to distance D from vehicle 11 to curb 31. It can be seen that the maximum value of difference diff in TOF with respect to curb 31 is much smaller than the maximum value of the difference in TOF with respect to person 21.

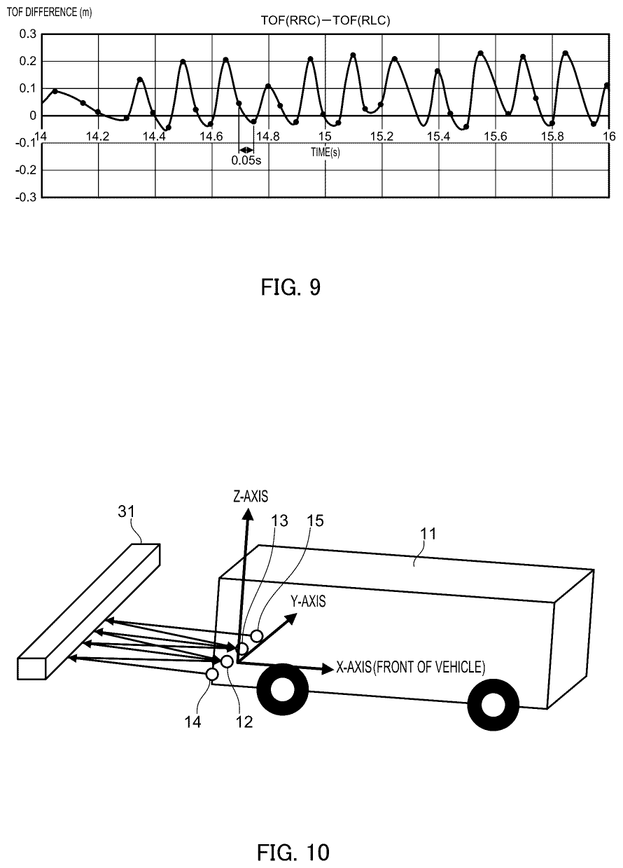

As illustrated in FIG. 12A, the transmissions of the sonar apparatuses are repeated at 50 ms intervals in the order of RRC 12, RLC 13, and both RL 15 and RR 14, RRC 12, and so forth. FIG. 12B illustrates a graph of the temporal change in the difference in TOF with respect to curb 31, calculated in the same manner as in FIG. 9 under the above-described conditions. The difference value of TOF increases as distance D decreases according to above-described Equation 2, but it can be seen that the range of fluctuation is considerably smaller than that in the case of pedestrian 21 illustrated in FIG. 9.

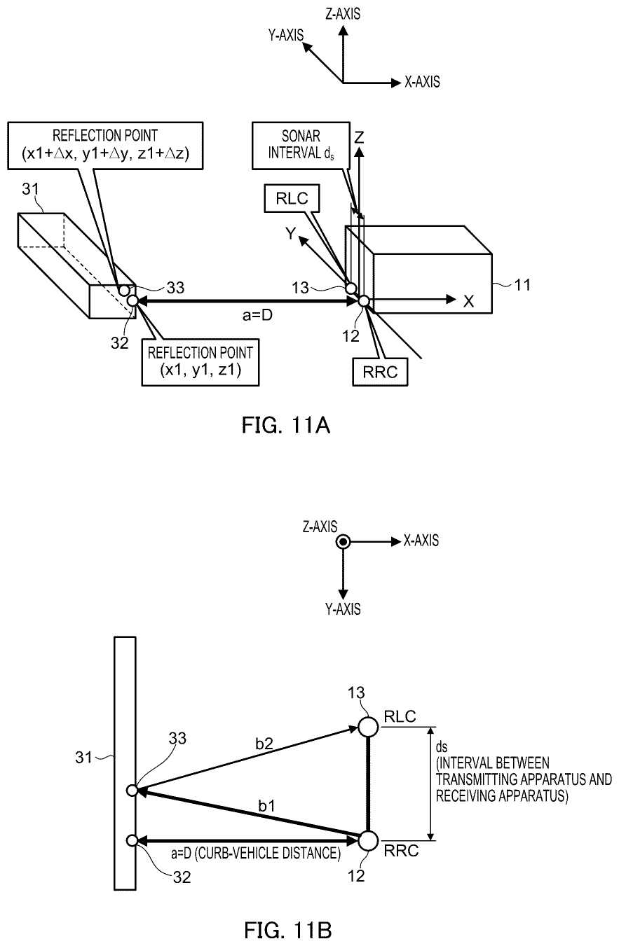

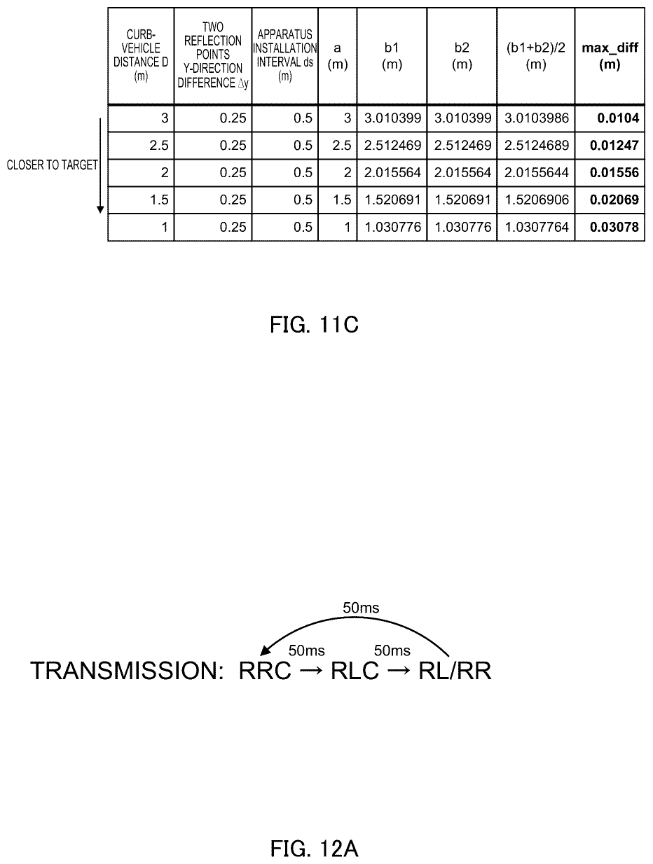

Next, a difference in TOF in a case where the ultrasonic wave is reflected by a pole will be described. As illustrated in FIGS. 13, 14A, and 14B, the first wave received by the sonar apparatus is a reflection that reaches the sonar apparatus via the shortest route. Further, since the shape of pole 41 is a cylinder, the reflection point in a case where the ultrasonic wave transmitted by a certain sonar apparatus is received by this certain sonar apparatus and the reflection point in a case where the ultrasonic wave transmitted by the certain sonar apparatus is received by another sonar apparatus are substantially the same.

Thus, in a case where the object to be detected is pole 41, the reflection point is the same, and thus, there is no positional difference in the reflection point, and Δx=Δy=Δz=0 may be set. In this case, the factor that affects the difference in the TOF of the ultrasonic wave received by RRC 12 and RLC 13 is the relative positional relationship between pole 41, RRC 12, and RLC 13.

In this case, TOF_{RRC} of the ultrasonic wave received by RRC 12 and TOF_{RLC} of the ultrasonic wave received by RLC 13 are as follows:

$${TOF}_{RRC} = a = \sqrt{( x - {{x}_{s 1 )}}^{2} + ( y - {{y}_{s 1 )}}^{2}} \\ {TOF}_{RLC} = \frac{b 1 + b 2}{2} = \frac{\sqrt{( x - {{x}_{s 1 )}}^{2} + ( y - {{y}_{s 1 )}}^{2}} + \sqrt{( x - {{x}_{s 2 )}}^{2} + ( y - {{y}_{s 2 )}}^{2}}}{2}$$

Accordingly, difference diff in the TOF of the ultrasound received by RRC 12 and RLC 13 is as follows:

$$\begin{matrix}diff = {TOF}_{RLC} - {TOF}_{RRC} \\ = \frac{b 1 + b 2}{2} - a \\ = \frac{\sqrt{( x - {{x}_{s 2 )}}^{2} + ( y - {{y}_{s 2 )}}^{2}} - \sqrt{( x - {{x}_{s 1 )}}^{2} + ( y - {{y}_{s 1 )}}^{2}}}{2}\end{matrix}$$

Here, the minimum value of TOF_{RRC} is the distance between pole 41 and vehicle 11, and thus min TOF_{RRC}=a=D. Further, when the interval between RRC 12 and RLC 13 is dₛ, the maximum value of TOF_{RLC} is as follows:

$$max {TOF}_{RLC} = \sqrt{{D}^{2} + d {s}^{2}} .$$

Accordingly, the maximum value of difference diff in TOF is as follows:

$$max ( diff ) = \frac{\sqrt{{D}^{2} + d {s}^{2}} - D}{2} . \qquad ( Equation 3 )$$

FIG. 14C illustrates the maximum value (max_diff) of difference diff that varies according to distance D from vehicle 11 to pole 41. It can be seen that the maximum value of difference diff in TOF with respect to pole 41 is much smaller than the maximum value of the difference in TOF with respect to pedestrian 21.

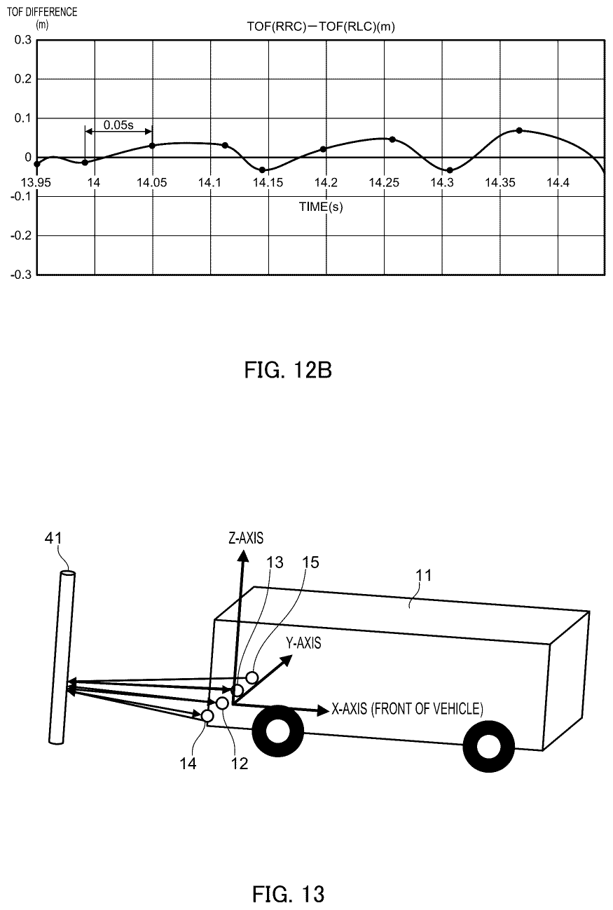

FIG. 15 illustrates a graph of the temporal change in the difference in TOF with respect to pole 41, calculated in the same manner as in FIG. 9. The difference value of TOF increases slightly as distance D decreases according to above-described Equation 3, but the increase is a few centimeters, and the range of fluctuation is found to be considerably smaller than that in the case of pedestrian 21 illustrated in FIG. 9.

Hereinafter, embodiments implemented based on such findings will be described in detail.

### Embodiment 1

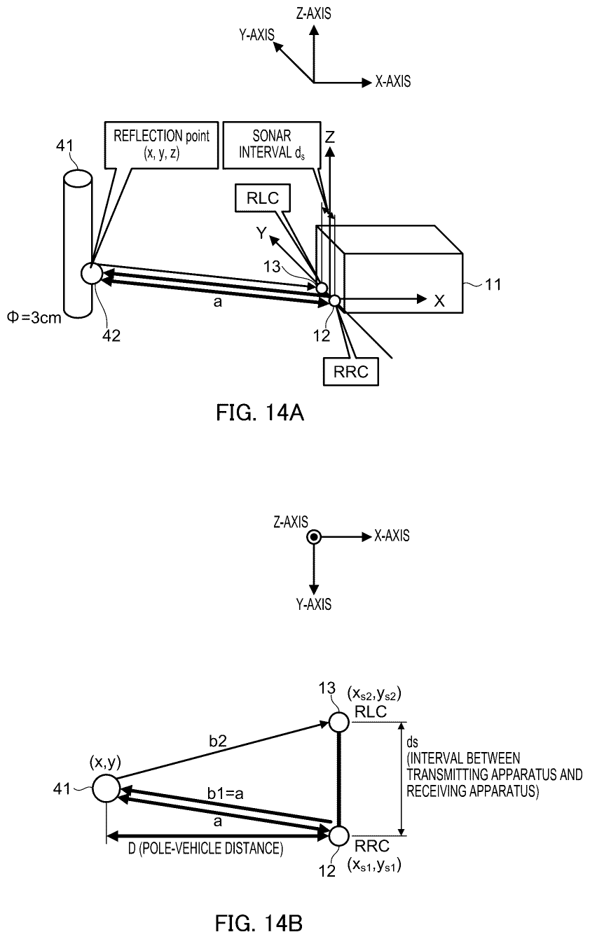

FIG. 16 illustrates an exemplary configuration of determination apparatus 51 according to Embodiment 1. Determination apparatus 51 includes a plurality of sonar apparatuses 52, input section 53, difference calculator 54, shortest-distance calculator 55, object threshold calculator 56, object determiner 57, and output section 58.

Each of sonar apparatuses 52 transmits ultrasonic waves, receives ultrasonic waves reflected by an object to be detected, and outputs information corresponding to the TOF and the reflection intensity. Sonar apparatuses 52 correspond respectively to RRC 12, RLC 13, RR 14, and RL 15 described above.

Input section 53 receives an input of the TOF and the reflection intensity information output from each sonar apparatus 52. Difference calculator 54 acquires information such as the number of sonar apparatuses from sonar mounting information 59 stored in a storage, calculates the difference between TOFs output from sonar apparatuses 52, and outputs the result to object determiner 57.

Shortest-distance calculator 55 calculates the shortest distance from the vehicle to the object based on information of the first wave reflected by the object, and outputs the result to object threshold calculator 56.

Object threshold calculator 56 calculates the threshold of the difference in TOF for each object corresponding to the shortest distance calculated by shortest-distance calculator 55, based on object threshold information 60 stored in the storage. Here, information on the shortest distance and the threshold of the difference in TOF is registered in object threshold information 60 in association with the type of the object. By changing the threshold according to the minimum distance, it is possible to accurately determine the object.

Object determiner 57 compares the value of each difference calculated by difference calculator 54 with the threshold of the difference in TOF for each object calculated by object threshold calculator 56, and determines the type of the object.

Output section 58 outputs information of the determination result by object determiner 57 to an electronic control unit (ECU) of the vehicle or the like. This information is used for control of Autonomous Emergency Braking and the like.

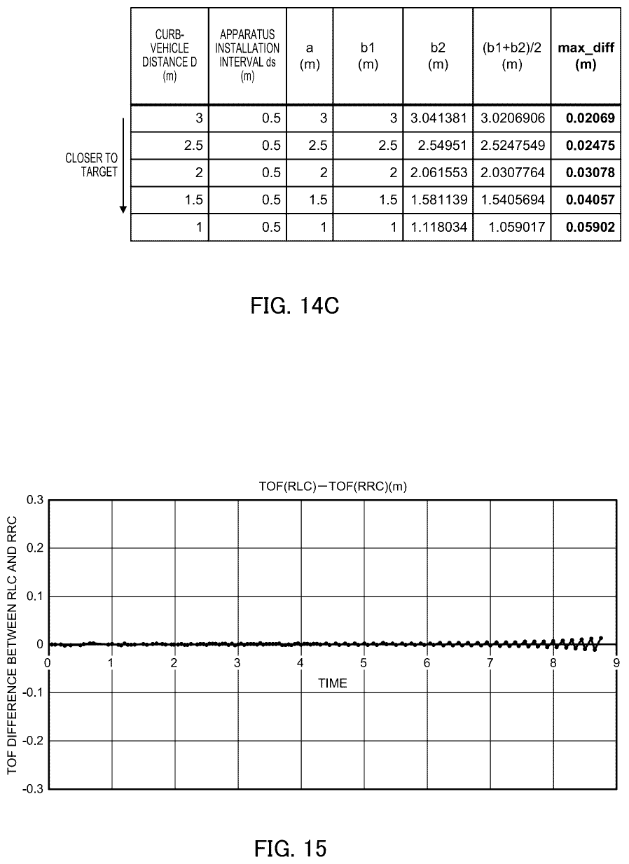

Next, type determination processing on the object performed by determination apparatus 51 will be described. As illustrated in FIG. 17, first, object threshold calculator 56 of determination apparatus 51 acquires sonar mounting information 59 and object threshold information 60 (step S1).

Then, input section 53 receives the input of information on reflection intensity Pᵢ (i=1, . . . , N) of the ultrasonic wave measured by each sonar apparatus 52 and distance TOFᵢ (i=1, . . . , N) to the object (step S2). Here, it is assumed that there are N sonar apparatuses.

Subsequently, difference calculator 54 determines whether reflection intensity Pᵢ is within the range larger than threshold Th₁ and smaller than threshold Th₂ (step S3). Thresholds Th₁ and Th₂ are set in advance. Note that, threshold Th₁ and threshold Th₂ are different depending on the distance to the object.

In a case where reflection intensity Pᵢ is not within the range larger than threshold Th₁ and smaller than threshold Th₂ (step S3, NO), the processing in step S2 is executed again.

In a case where reflection intensity Pᵢ is within the range larger than threshold Th₁ and smaller than threshold Th₂ (step S3, YES), difference calculator 54 calculates difference value diff(i, j) (i, j=1, . . . , N) for each TOFᵢ, and shortest-distance calculator 55 calculates minimum value TOFₘᵢₙ of distance TOFᵢ (step S4). Here, diff(i, j)=|TOFᵢ−TOFⱼ|(i≠j).

Subsequently, object threshold calculator 56 calculates the threshold of the difference in TOF for the object corresponding to minimum value TOFₘᵢₙ of the distance based on object threshold information 60 (step S5). Here, three objects are pedestrian 21, curb 31, and pole 41, and thresholds Th_{ped}, Th_{curb}, and Thₚₒₗₑ corresponding to minimum value TOFₘᵢₙ of the distance are set for them, respectively.

Then, object determiner 57 determines whether all of difference values diff(i, j) (i, j=1, . . . , N) are smaller than threshold Thₚₒₗₑ of pole 41 (step S6).

In a case where all of difference values diff(i, j) are smaller than threshold Thₚₒₗₑ of pole 41 (step S6, YES), object determiner 57 further calculates S0 coordinate, S1 coordinate, S4 coordinate, and S5 coordinate using the above-described triangulation (step S13), determines whether the y-axis (vehicle width direction) values of the calculated coordinates varies beyond a predetermined range (step S14), and in a case where the y-axis values do not vary beyond the range (step S14, NO), determines that the object is pole 41 (step S15), and output section 58 outputs the determination result (step S10). In a case where the variation occurs (step S14, YES), the process moves to step S7.

In a case where any of difference values diff(i, j) (i, j=1, . . . , N) is equal to or larger than threshold Thₚₒₗₑ of pole 41 (step S6, NO), or in a case where the values of the y-axes (vehicle width direction) of the calculated S0 coordinate, S1 coordinate, S4 coordinate, and S5 coordinate vary beyond the predetermined range, object determiner 57 determines whether all of difference values diff(i, j) (i, j=1, . . . , N) are smaller than threshold Th_{curb} of curb 31 (step S7).

In a case where all of difference values diff(i, j) (i, j=1, . . . , N) are smaller than threshold Th_{curb} of curb 31 (step S7, YES), object determiner 57 determines that the object is curb 31 (step S12), and output section 58 outputs the determination result (step S10).

In a case where any of difference values diff(i, j) (i, j=1, . . . , N) is equal to or larger than threshold Th_{curb} of curb 31 (step S7, NO), object determiner 57 determines whether all of difference values diff(i, j) (i, j=1, . . . , N) are smaller than threshold Th_{ped} of pedestrian 21 (step S8).

In a case where all of the difference values diff(i, j) (i, j=1, . . . , N) are smaller than threshold Th_{ped} of pedestrian 21 (step S8, YES), object determiner 57 determines that the object is pedestrian 21 (step S11), and output 58 section outputs the determination result (step S10).

In a case where any of difference values diff(i, j) (i, j=1, . . . , N) is equal to or larger than threshold Th_{ped} of pedestrian 21 (step S8, NO), object determiner 57 determines that the object is an object other than pedestrian 21, curb 31, and pole 41 (step S9), and output sections 58 outputs the determination result (step S10).

As described above, by performing the determination of the object based on the difference value of the distance to the object measured by each sonar apparatus, determination apparatus 51 can accurately perform the determination of the object.

### Embodiment 2

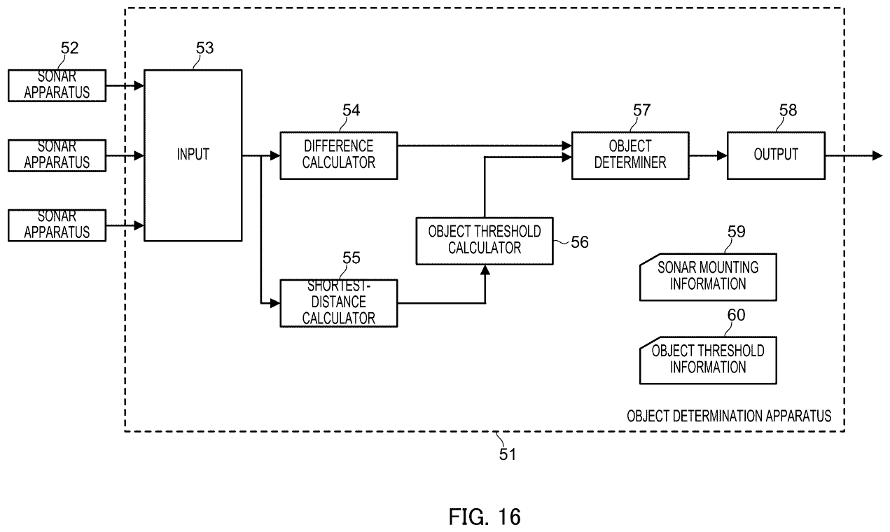

FIG. 18 illustrates an exemplary configuration of determination apparatus 61 according to Embodiment 2. As illustrated in FIG. 18, determination apparatus 61 further includes cache 62 in addition to the configuration of determination apparatus 51 in Embodiment 1.

Cache 62 receives information of the difference value of the TOF at each time t from difference calculator 54, and buffers the difference values of the TOFs of the past M transmission frames.

Object determiner 57 calculates the maximum difference value among the difference values of the TOFs of the past M transmission frames buffered in cache 62. Note that, as illustrated in FIG. 12A, the sonar apparatus that transmits the wave is switched in each transmission frame. Then, the determination of the object is performed by comparing the maximum difference value with the threshold value of the difference in TOF for each object.

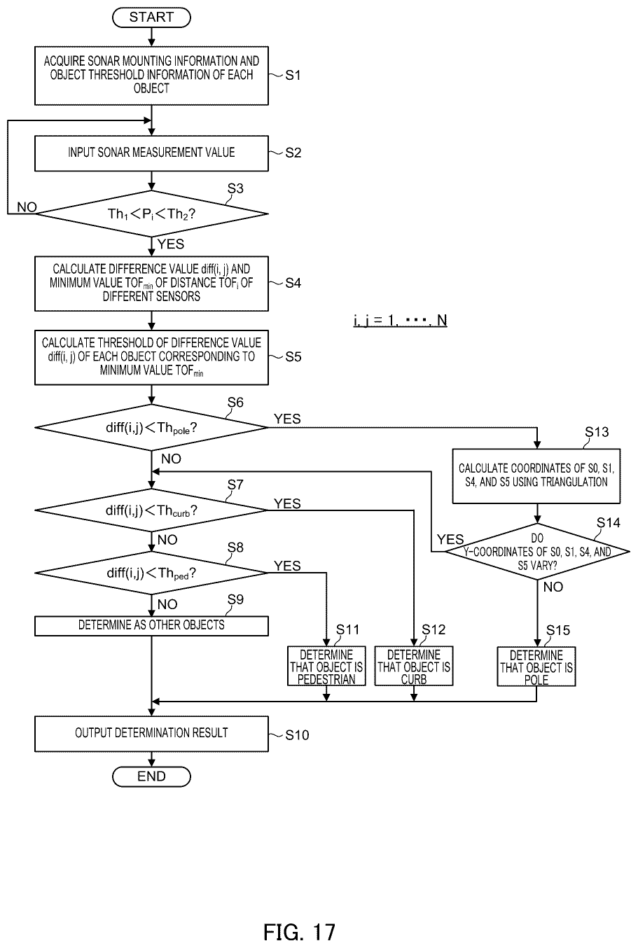

Next, the type determination processing on the object performed by determination apparatus 61 will be described. As illustrated in FIG. 19, first, object threshold calculator 56 of determination apparatus 61 acquires sonar mounting information 59 and object threshold information 60 (step S21).

Then, input section 53 receives the input of information on reflection intensity Pᵢ (i=1, . . . , N) of the ultrasonic wave measured by each sonar apparatus 52 at time t and distance TOF; (t) (i=1, . . . , N) to the object (step S22). Here, it is assumed that there are N sonar apparatuses.

Subsequently, difference calculator 54 determines whether reflection intensity Pᵢ is within a predetermined range that is greater than threshold Th₁ and less than threshold Th₂ (step S23). Thresholds Th₁ and Th₂ are set in advance.

In a case where reflection intensity Pᵢ is not within the predetermined range larger than threshold Th₁ and smaller than threshold Th₂ (step S23, NO), the processing in step S22 is executed again.

In a case where reflection intensity Pᵢ is within the predetermined range larger than threshold Th₁ and smaller than threshold Th₂ (step S23, YES), difference calculator 54 calculates difference value diff(i, j, t) (i, j=1, . . . , N) for each TOFᵢ(t), and shortest-distance calculator 55 calculates minimum value TOFₘᵢₙ of distance TOFᵢ(t) and outputs the minimum value to object threshold calculator 56. Object threshold calculator 56 calculates the threshold of the difference in TOF for the object corresponding to input distance minimum value TOFₘᵢₙ based on object threshold information 60 obtained in step S21. Cache 62 buffers difference value diff(i, j, t) of the distances in the past M transmission frames and the threshold of the difference in TOF for the objects corresponding to the minimum value TOFₘᵢₙ (step S24). Here, diff(i, j, t)=|TOFᵢ(t)−TOFⱼ(t)|(i≠j).

Subsequently, object determiner 57 calculates maximum value diffₘₐₓ(t) of difference value diff(i, j, t) of the distance in the past M transmission frames including time t (step S25). Here, diffₘₐₓ(t)=max (diff(i, j, t−(M−1)), . . . , diff(i, j, t)).

Then, object determiner 57 determines whether maximum value diffₘₐₓ(t) is smaller than threshold Thₚₒₗₑ of pole 41 (step S26). Note that threshold Thₚₒₗₑ is set in advance.

In a case where maximum value diffₘₐₓ(t) is smaller than threshold Thₚₒₗₑ of pole 41 (step S26, YES), object determiner 57 further calculates the S0 coordinate, the S1 coordinate, the S4 coordinate, and the S5 coordinate using the triangulation described above (step S33), determines whether the y-axis (vehicle width direction) values of the calculated coordinates varies beyond a predetermined range (step S34), and in a case where the y-axis values do not vary beyond the range (step S34, NO), determines that the object is pole 41 (step S35), and output section 58 outputs the determination result (step S30). In a case where the variation occurs (step S34, YES), the process moves to step S27.

In a case where maximum value diffₘₐₓ(t) is equal to or larger than threshold Thₚₒₗₑ of pole 41 (step S26, NO), or in a case where the values of the y-axes (vehicle width direction) of the calculated S0 coordinate, S1 coordinate, S4 coordinate, and S5 coordinate vary beyond the predetermined range, object determiner 57 determines whether maximum value diffₘₐₓ(t) is smaller than threshold Th_{curb} of curb 31 (step S27).

In a case where maximum value diffₘₐₓ(t) is smaller than threshold Th_{curb} of curb 31 (step S27, YES), object determiner 57 determines that the object is curb 31 (step S32), and output section 58 outputs the determination result (step S30).

In a case where maximum value diffₘₐₓ(t) is equal to or larger than threshold Th_{curb} of curb 31 (step S27, NO), object determiner 57 determines whether maximum value diffₘₐₓ(t) is smaller than threshold Th_{ped} of pedestrian 21 (step S28).

In a case where maximum value diffₘₐₓ(t) is smaller than threshold Th_{ped} of pedestrian 21 (step S28, YES), object determiner 57 determines that the object is pedestrian 21 (step S31), and output section 58 outputs the determination result (step S30).

In a case where maximum value diffₘₐₓ(t) is equal to or larger than threshold Th_{ped} of pedestrian 21 (step S28, NO), object determiner 57 determines that the object is something other than pedestrian 21, curb 31, or pole 41 (step S29), and output section 58 outputs the determination result (step S30).

As described above, by performing the determination of the object based on the maximum value of the difference in the distance to the object from the M buffered frames measured by each sonar apparatus, determination apparatus 61 can accurately perform the determination of the object.

### Embodiment 3

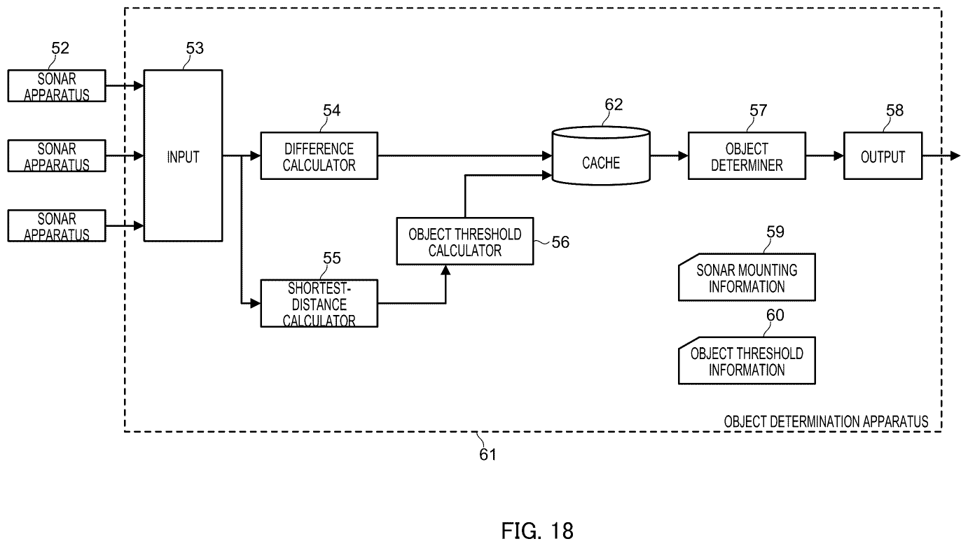

FIG. 20 illustrates an exemplary configuration of determination apparatus 71 according to Embodiment 3. As illustrated in FIG. 20, determination apparatus 71 includes pedestrian determiner 72 and transmission control output 73 in addition to the configuration of determination apparatus 61 of Embodiment 2.

Pedestrian determiner 72 determines whether the object is pedestrian 21 based on the latest information of difference values of TOF. In a case where the object is determined to be pedestrian 21, transmission control output 73 causes the transmission apparatus corresponding to the latest TOF to continue transmitting ultrasound in the next transmission period.

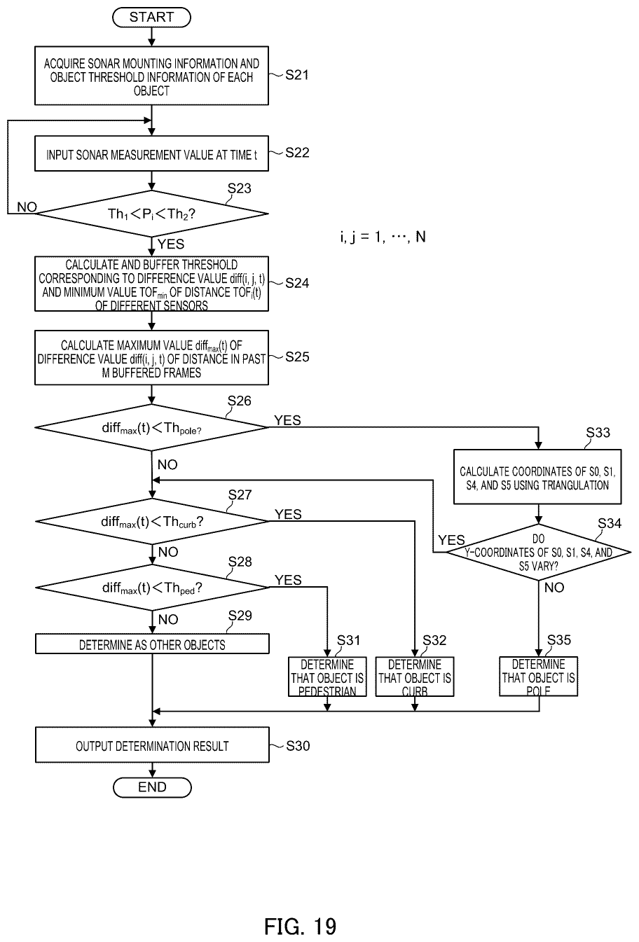

Next, the type determination processing on the object performed by determination apparatus 71 will be described. As illustrated in FIG. 21, first, object threshold calculator 56 of determination apparatus 71 acquires sonar mounting information 59 and object threshold information 60 (step S41).

Then, input section 53 receives the input of information on reflection intensity Pᵢ (i=1, . . . , N) of the ultrasonic wave measured by each sonar apparatus 52 at time t and distance TOFᵢ(t) (i=1, . . . , N) to the object (step S42). Here, it is assumed that there are N sonar apparatuses.

Subsequently, difference calculator 54 determines whether reflection intensity Pᵢ is within the range larger than threshold Th₁ and smaller than threshold Th₂ (step S43). Thresholds Th₁ and Th₂ are set in advance.

In a case where reflection intensity Pᵢ is not within the range larger than threshold Th₁ and smaller than threshold Th₂ (step S43, NO), the processing in step S42 is executed again.

In a case where reflection intensity Pᵢ is within the range larger than threshold Th₁ and smaller than threshold Th₂ (step S43, YES), difference calculator 54 calculates difference value diff(i, j, t) (i, j=1, . . . , N) for each TOFᵢ(t), and shortest-distance calculator 55 calculates minimum value TOFₘᵢₙ of distance TOFᵢ(t) and outputs the minimum value to object threshold calculator 56. Object threshold calculator 56 calculates the threshold of the difference in TOF for the objects corresponding to the minimum input distance value TOFₘᵢₙ, based on object threshold information 60 obtained in step S41. Cache 62 buffers difference value diff(i, j, t) of the distances in the past M transmission frames and the threshold of the difference in TOF for the objects corresponding to the minimum value TOFₘᵢₙ (step S44). Here, diff(i, j, t)=|TOFᵢ(t)−TOFⱼ(t)|(i≠j).

Further, difference calculator 54 calculates maximum value diffₘₐₓ(t, 1) of difference value diff(i, j, t) at time t, and object determiner 57 calculates maximum value diffₘₐₓ(t, M) of distance difference value diff(i, j, t) of the past M transmission frames buffered in cache 62 (step S45).

Here, diffₘₐₓ(t, 1)=max (diff(i, j, t)) (i, j=1, . . . , N), and diffₘₐₓ(t, M)=max (diff (i, j, t−(M−1)), . . . , diff(i, j, t)) (i, j=1, . . . , N).

Then, pedestrian determiner 72 determines whether maximum value diffₘₐₓ(t, 1) of difference value diff(i, j, t) at time t is larger than threshold Th_{curb} of curb 31 and is smaller than threshold Th_{ped} of pedestrian 21 (step S46). Note that threshold Th_{curb} and threshold Th_{ped} are set in advance.

In a case where maximum value diffₘₐₓ(t, 1) is larger than threshold Th_{curb} of curb 31 and is smaller than threshold Th_{ped} of pedestrian 21 (step S46, YES), there is a high possibility that pedestrian 21 is accurately detected.

Thus, transmission controller 73 changes a control signal for each sonar apparatus 52 in order to maintain the current good detection state for pedestrian 21 in the next transmission period, and controls each sonar apparatus 52 such that sonar apparatus 52 currently performing transmission continues to perform transmission without switching of sonar apparatus 52 that performs transmission (step S55).

After the processing in step S55, or in a case where maximum value diffₘₐₓ(t, 1) is equal to or less than threshold Th_{curb} of curb 31 or is equal to or greater than threshold Th_{ped} of pedestrian 21 in step S46 (step S46, NO), object determiner 57 determines whether maximum value diffₘₐₓ(t, M) is smaller than threshold Thₚₒₗₑ of pole 41 (step S47). Note that threshold Thₚₒₗₑ is set in advance. In this case, in the next transmission period, the switching of sonar apparatus 52 that is to perform transmission is performed as illustrated in FIG. 12A.

In a case where maximum value diffₘₐₓ(t, M) is smaller than threshold Thₚₒₗₑ of pole 41 (step S47, YES), object determiner 57 further calculates S0 coordinate, S1 coordinate, S4 coordinate, and S5 coordinate using the above-described triangulation (step S56), determines whether the y-axis (vehicle width direction) values of the calculated coordinates varies beyond a predetermined range (step S57), and in a case where the y-axis values do not vary (step S57, NO) beyond the range, determines that the object is pole 41 (step S58), and output section 58 outputs the determination result (step S51). In a case where the variation occurs (step S57, YES), the process moves to step S48.

In a case where maximum value diffₘₐₓ(t, M) is equal to or larger than threshold Thₚₒₗₑ of pole 41 (step S47, NO), or in a case where the values of the y-axes (vehicle width direction) values of the calculated S0 coordinate, S1 coordinate, S4 coordinate, and S5 coordinate vary beyond the predetermined range, object determiner 57 determines whether maximum value diffₘₐₓ(t, M) is smaller than threshold Th_{curb} of curb 31 (step S48).

In a case where maximum value diffₘₐₓ(t, M) is smaller than threshold Th_{curb} of curb 31 (step S48, YES), object determiner 57 determines that the object is curb 31 (step S53), and output section 58 outputs the determination result (step S51).

In a case where maximum value diffₘₐₓ(t, M) is equal to or larger than threshold Th_{curb} of curb 31 (step S48, NO), object determiner 57 determines whether maximum value diffₘₐₓ(t, M) is smaller than threshold Th_{ped} of pedestrian 21 (step S49).

In a case where maximum value diffₘₐₓ(t, M) is smaller than threshold Th_{ped} of pedestrian 21 (step S49, YES), object determiner 57 determines that the object is pedestrian 21 (step S52), and output section 58 outputs the determination result (step S51).

In a case where maximum value diffₘₐₓ(t, M) is equal to or larger than threshold Th_{ped} of pedestrian 21 (step S49, NO), object determiner 57 determines that the object is something other than person 21, curb 31, and pole 41 (step S50), and output section 58 outputs the determination result (step S51).

In this manner, in a case where the possibility that pedestrian 21 is detected is high, the current good detection state for pedestrian 21 can be maintained by continuing the transmission with sonar apparatus 52, which is currently performing transmission, in the next transmission period.

### Embodiment 4

In Embodiment 4, a case where a walking action of a pedestrian is detected using distance information detected by one or more sonar apparatuses will be described. When a person walks, the hands and legs move, and the reflection point changes over time. Thus, the detected distance changes.

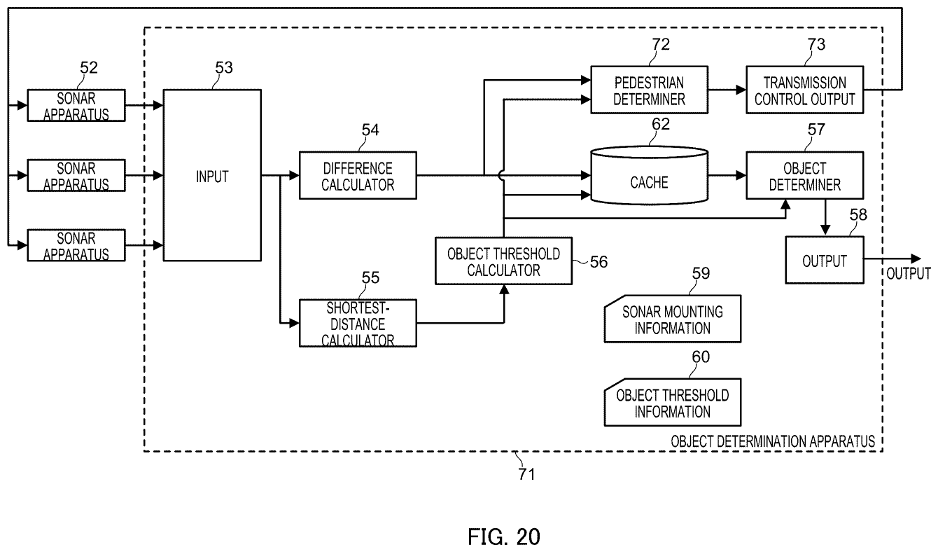

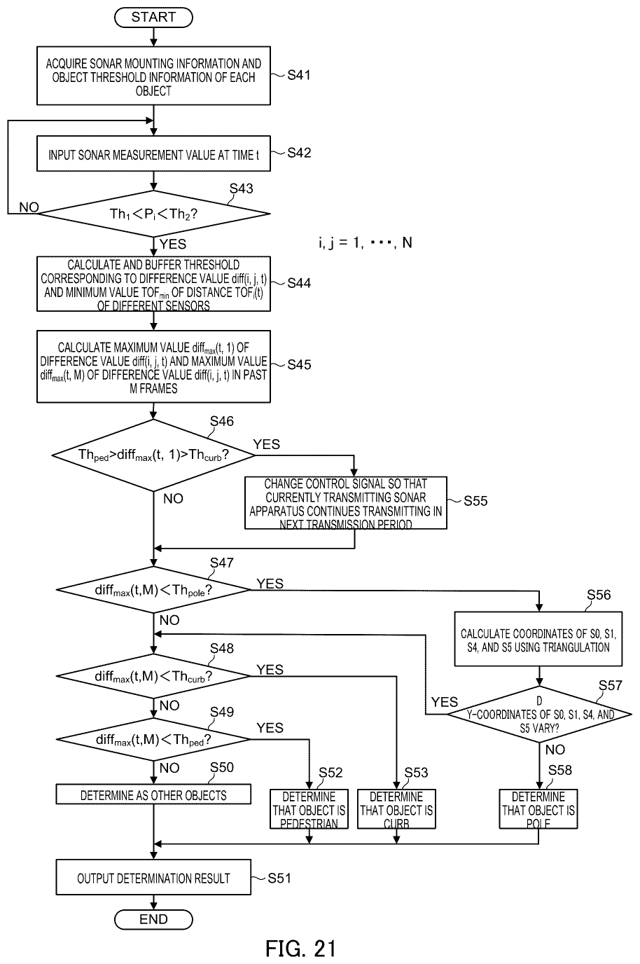

FIG. 22 illustrates a case where, for example, the sonar apparatus that transmits a wave is RRC 12, and the sonar apparatus that receives a wave is RLC 13. In this example, the reflection point of the transmitted ultrasound is right knee 101 of pedestrian 21. Further, in FIG. 23, the reflection point changes, and the reflection point of the transmitted ultrasonic wave is head 102 of pedestrian 21. As described above, the reflection point of the ultrasonic wave changes from right knee 101 to head 102 due to the walking motion of pedestrian 21, and the detected distance becomes larger than that in the previous transmission frame, for example.

Further, also in a case where the sonar apparatus that transmits a wave is RLC 13 and the sonar apparatus that receives a wave is RLC 13, or in a case of another combination of sonar apparatuses, the hands and legs move and the reflection point changes with time when a person walks, and as a result, the detected distance changes.

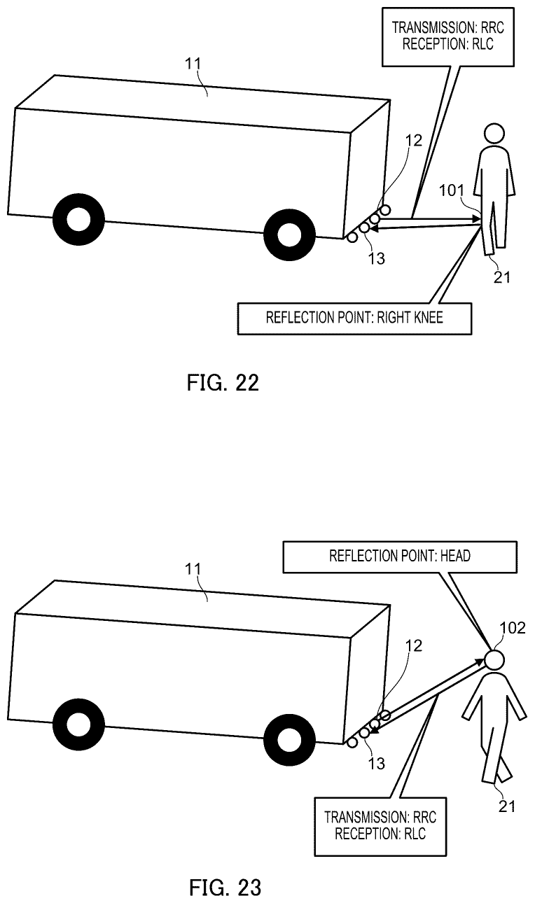

FIG. 24 illustrates an example of data used for determining whether the object is a pedestrian. FIG. 24 is data used, for example, in determining whether the detected distance acquired by RLC 13 corresponds to a pedestrian. This data includes four pieces of information: the vehicle speed, the transmission time, the number of the transmission apparatus, and the detected distance. The number of the transmission apparatus is the number of the sonar apparatus that transmits the reflected wave received by RLC 13.

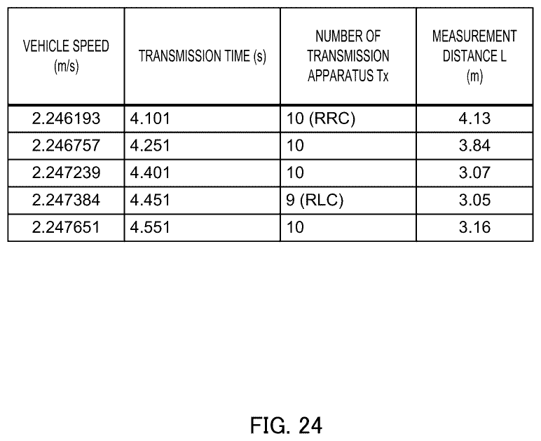

To determine whether the object is a pedestrian, the difference between the actual measurement distance from the sonar apparatus to the pedestrian and the estimation distance from the sonar apparatus to the pedestrian is used. Hereinafter, the method will be described. FIG. 25 illustrates a method for calculating a distance estimation value from a sonar apparatus used for determining whether an object is a pedestrian to the pedestrian. Hereinafter, a method for determining whether an object is a pedestrian or not using the measurement distance obtained by receiving the ultrasonic wave transmitted by RRC 12 with RLC 13, will be described.

First, the estimation distance is calculated from the information on the vehicle speed, the transmission time, and the measurement distance corresponding to the transmission apparatus number 10, which is the number of RRC 12. Here, the information on the measurement distance used in calculating the estimation distance is the information at the time of the previous transmission.

For example, estimation distance L is calculated by equation Lᵢ₋₁−v×Δt. Here, Lᵢ₋₁ is the measurement distance at the previous transmission timing, v is the vehicle speed, and Δt is the elapsed time between the previous transmission time and the transmission time for which the estimation distance is to be calculated. The estimation distance is the distance between the sonar apparatus and the object, assuming that the object is a stationary object.

In a case where the object is a stationary object, the probability that the reflection point changes is low in the same combination of a sonar apparatus that transmits ultrasonic waves and a sonar apparatus that receives the ultrasonic waves, and thus, the difference between the measurement distance and the estimation distance is small. In contrast, in the case of a moving object such as a pedestrian, the probability that the difference between the measurement distance and the estimation distance becomes large increases. Thus, by calculating the difference between the measurement distance and the estimation distance, it is possible to determine whether the object is moving or not.

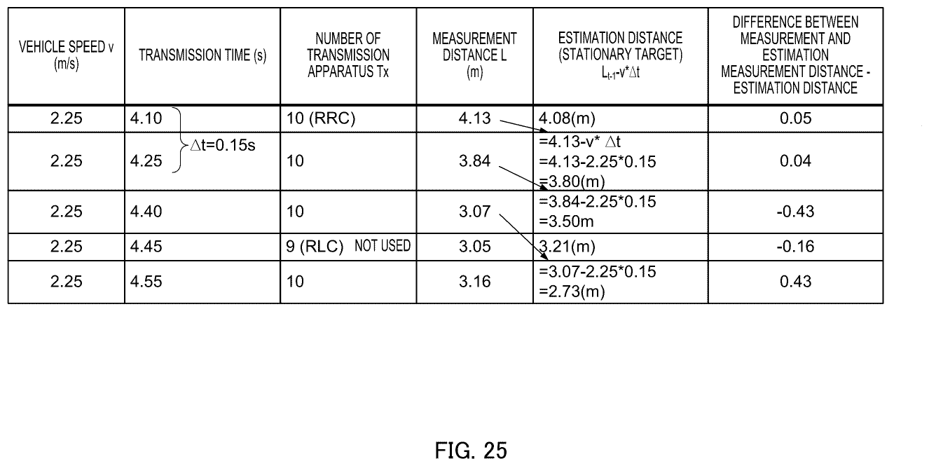

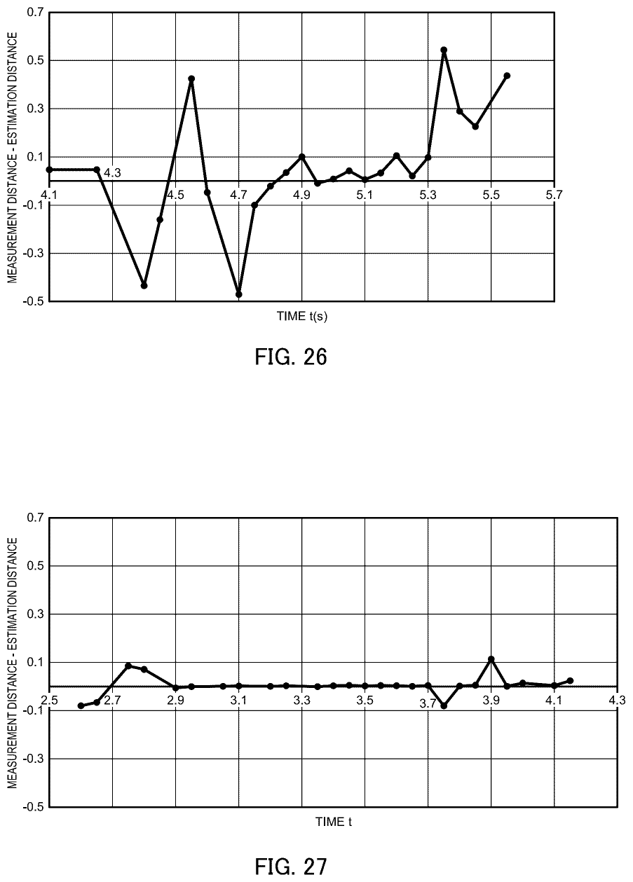

FIG. 26 illustrates a calculation result of a difference between a measurement distance and an estimation distance for a moving object. FIG. 27 illustrates a calculation result of a difference between a measurement distance and an estimation distance for a stationary object. Here, a doll is used as the object in the experiment.

As illustrated in FIG. 26, in the case of a moving object, the absolute value of the difference between the measurement distance and the estimation distance becomes larger. In contrast, in the case of a stationary object as illustrated in FIG. 27, the absolute value of the difference between the measurement distance and the estimation distance is small. It is thus possible to determine whether the object is moving or not by setting a threshold and comparing the absolute value with the threshold.

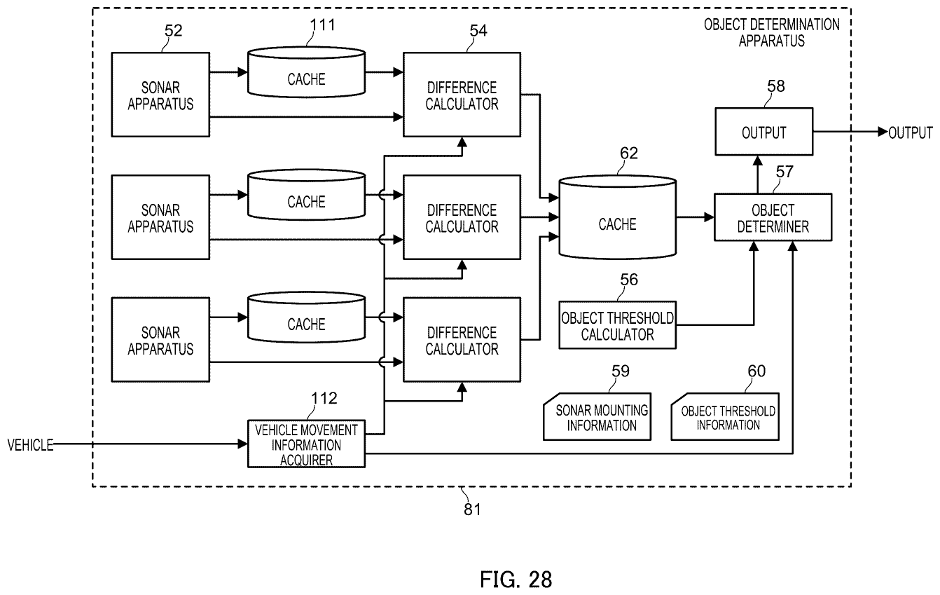

FIG. 28 illustrates an exemplary configuration of determination apparatus 81 according to Embodiment 4. As illustrated in FIG. 28, determination apparatus 81 includes one or more sonar apparatuses 52, caches 111 corresponding in number to the sonar apparatuses, difference calculators 54 corresponding in number to the sonar apparatuses, vehicle movement information acquirer 112, cache 62, object threshold calculator 56, object determiner 57, and output section 58.

Each sonar apparatus 52 receives the ultrasonic wave reflected by the object and outputs information on the reflection intensity corresponding to the TOF. Sonar apparatuses 52 corresponds respectively to RRC 12, RLC 13, RR 14, and RL 15 described above.

Each cache 111 receives the input of information on the reflection intensity of the ultrasonic wave and distance TOFᵢ (i=1, . . . , N) to the object measured by a sonar apparatus 52 corresponding to the cache 111, and buffers the information.

Each difference calculator 54 acquires information such as the number of sonar apparatuses from sonar mounting information 59 stored in the storage, acquires information on the measurement distance to the object, the vehicle speed, and the transmission interval, and estimates the distance to the object. Further, each difference calculator 54 calculates the difference between the measurement distance and the estimation distance at the current time, and buffers the difference in cache 62.

Vehicle movement information acquirer 112 acquires information such as the speed of the vehicle and outputs it to difference calculator 54. Cache 62 buffers the difference information calculated by each difference calculator 54.

Object threshold calculator 56 calculates the threshold of the difference calculated by difference calculator 54 based on object threshold information 60 stored in the storage. Here, information on the threshold of the difference is registered in object threshold information 60 in association with the type of the object.

Object determiner 57 calculates the maximum value of the past M differences, including time t buffered in cache 62. Further, object determiner 57 compares the value of the difference calculated by difference calculator 54 with the threshold calculated by object threshold calculator 56, and determines the type of the object.

Output section 58 outputs information on the determination result by object determiner 57 to an ECU of the vehicle or the like. This information is used for control of Autonomous Emergency Braking of a vehicle.

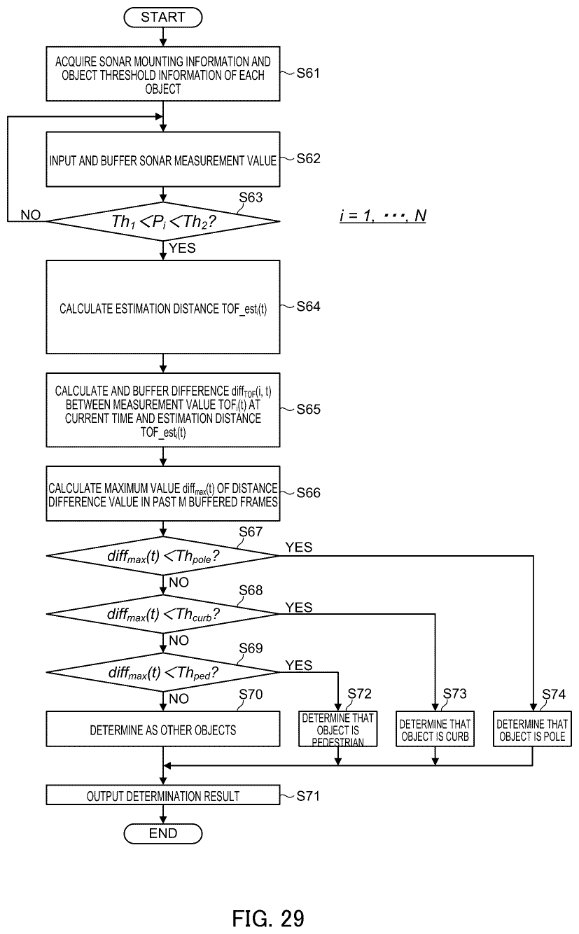

Next, the type determination processing on the object performed by determination apparatus 81 will be described. As illustrated in FIG. 29, first, object threshold calculator 56 of determination apparatus 81 acquires sonar mounting information 59 and object threshold information 60 (step S61).

Then, each cache 111 receives the input of information on the reflection intensity Pᵢ (i=1, . . . , N) of the ultrasonic wave measured by sonar apparatus 52 corresponding to each cache apparatus 111 and distance TOFᵢ (i=1, . . . , N) to the object (step S62), and buffers the information (step S62). Here, it is assumed that there are N (N>=1) sonar apparatuses.

Subsequently, difference calculator 54 determines whether reflection intensity Pᵢ is within the range larger than threshold Th₁ and smaller than threshold Th₂ (step S63). Thresholds Th₁ and Th₂ are set in advance.

In a case where reflection intensity Pᵢ is not within the range larger than threshold Th₁ and smaller than threshold Th₂ (step S63, NO), the processing in step S62 is executed again.

In a case where reflection intensity Pᵢ is within the range larger than threshold Th₁ and smaller than threshold Th₂ (step S63, YES), difference calculator 54 acquires measurement distance TOFᵢ(t−1) measured at one previous time t−1 from cache 111 corresponding to each sonar apparatus 52, information on vehicle speed v from vehicle movement information acquirer 112, and information on transmission interval Δt (=Tᵢ−Tᵢ₋₁) from sonar apparatus 52, and calculates estimation distance TOF_estᵢ(t) corresponding to each sonar apparatus by the following equation (step S64):

$${TOF\_est}_{i} ( t ) = {TOF}_{i} ( t - 1 ) - v \times ( {T}_{i} - {T}_{i - 1} ) .$$

Further, difference calculator 54 calculates difference diff_{TOF}(i, t) between measurement value TOFᵢ(t) at the current time and the estimation distance TOF_estᵢ(t) according to the following equation, and buffers the difference in cache 62 (step S65).

$${diff}_{TOF} ( i , t ) = \vert {TOF}_{i} ( t ) - {TOF\_est}_{i} ( t ) \vert$$

Subsequently, object determiner 57 calculates maximum value diffₘₐₓ(t) of past M differences diff_{TOF}(i, t) including time t buffered in cache 62 (step S66). Here, diffₘₐₓ(t)=max (diff_{TOF}(i, t−(M−1)), . . . , diff_{TOF}(i, t)).

Then, object determiner 57 determines whether maximum value diffₘₐₓ(t) is smaller than threshold Thₚₒₗₑ of pole 41 (step S67). Note that threshold Thₚₒₗₑ is set in advance.

In a case where maximum value diffₘₐₓ(t) is smaller than threshold Thₚₒₗₑ of pole 41 (step S67, YES), object determiner 57 determines that the object is pole 41 (step S74), and output section 58 outputs the determination result (step S71).

In a case where maximum value diffₘₐₓ(t) is equal to or larger than threshold Thₚₒₗₑ of pole 41 (step S67, NO), object determiner 57 determines whether maximum value diffₘₐₓ(t) is smaller than threshold Th_{curb} of curb 31 (step S68).

In a case where maximum value diffₘₐₓ(t) is smaller than threshold Th_{curb} of curb 31 (step S68, YES), object determiner 57 determines that the object is curb 31 (step S73), and output section 58 outputs the determination result (step S71).

In a case where maximum value diffₘₐₓ(t) is equal to or larger than threshold Th_{curb} of curb 31 (step S68, NO), object determiner 57 determines whether maximum value diffₘₐₓ(t) is smaller than threshold Th_{ped} of pedestrian 21 (step S69).

In a case where maximum value diffₘₐₓ(t) is smaller than threshold Th_{ped} of pedestrian 21 (step S69, YES), object determiner 57 determines that the object is pedestrian 21 (step S72), and output section 58 outputs the determination result (step S71).

In a case where maximum value diffₘₐₓ(t) is equal to or larger than threshold Th_{ped} of pedestrian 21 (step S69, NO), object determiner 57 determines that the object is something other than person 21, curb 31, and pole 41 (step S70), and output section 58 outputs the determination result (step S71).

As described above, by calculating the difference between the actual measurement distance from the sonar apparatus to the pedestrian and the estimation distance from the sonar apparatus to the pedestrian, it is possible to determine whether the object is a pedestrian with higher accuracy.

Note that, here, the difference between the actual measurement distance from the sonar apparatus to the pedestrian and the estimated value of the distance from the sonar apparatus to the pedestrian is calculated, but the determination of whether the object is a pedestrian or not may be performed using the difference in the time of flight of the ultrasonic wave corresponding to those distances.

While the embodiments have been described in detail, the present disclosure is not limited to the embodiments. For example, determination apparatuses 51, 61, 71, and 81 may be apparatuses configured to be mounted on a vehicle or apparatuses installed outside a vehicle.

Further, in the above embodiment, the determination of the object is performed based on the distance corresponding to the time of flight of the ultrasonic wave. However, since the distance is obtained by multiplying the time of flight of the ultrasonic wave by the velocity of the ultrasonic wave, the same determination can be easily performed even when the time of flight is used instead of the distance by adjusting the threshold used for the determination of the object.

Additionally, in the above embodiment, each component may be implemented by executing a software program suitable for each component. Each component may be realized by a program execution unit, such as a CPU or processor, reading and executing a software program recorded on a recording medium, such as a hard disk or semiconductor memory.

In addition, these generic or specific aspects of the present disclosure may be achieved by an apparatus, a method, an integrated circuit, a computer program, or a computer-readable recording medium such as CD-ROM, and also by any combination of the apparatus, the method, the integrated circuit, the computer program, and the recording medium.

In the above descriptions, the expression “section” used for the components may be replaced with another expression such as “assembly,” “circuit (circuitry),” “device,” “unit,” or “module.” The apparatus may be configured to be performed by CPU using program accumulated in a memory.

In addition, the present disclosure also includes implementations obtained by applying various modifications conceived by those skilled in the art to each embodiment, or implementations realized by arbitrarily combining components and functions in each embodiment without departing from the spirit of the present disclosure.

The disclosures of Japanese Patent Application No. 2024-023146, filed on Feb. 19, 2024, and Japanese Patent Application No. 2024-199481, filed on Nov. 15, 2024, including the specification, drawings and abstract, are incorporated herein by reference in its entirety.

### INDUSTRIAL APPLICABILITY

The present disclosure can be utilized in an object determination apparatus and an object determination method for determining an object.

### REFERENCE SIGNS LIST

11 Vehicle
12 RRC
13 RLC
14 RR
15 RL
21 Person (pedestrian)
22 Reflection point
31 Curb
41 Pole
51 Object determination apparatus
52 Sonar apparatus
53 Input Section
54 Difference calculator
55 Shortest-distance calculator
56 Object threshold calculator
57 Object determiner
58 Output Section
59 Sonar mounting information
60 Object threshold information
62 Cache
72 Pedestrian determiner
73 Transmission control output
111 Cache
112 Vehicle movement information acquirer

1. An object determination apparatus, comprising:
a calculation circuitry which, in operation, calculates a difference in time of flight of a plurality of ultrasonic waves reflected by an object and received by a plurality of sonar apparatuses, or a difference in distance corresponding to the time of flight; and
a determination circuitry which, in operation, determines a type of the object based on the difference.

2. The object determination apparatus according to claim 1, wherein
the determination circuitry which, in operation, determines the type based on a maximum value of the difference in a plurality of transmission periods.

3. The object determination apparatus according to claim 1, further comprising:
a control circuitry which, in operation, switches, among the plurality of sonar apparatuses, a sonar apparatus that transmits an ultrasonic wave of the plurality of ultrasonic waves for each transmission period, wherein
the control circuitry which, in operation, causes the sonar apparatus that transmits the ultrasonic wave corresponding to the difference to continue transmission in a next transmission period in a case where the type is determined to be a pedestrian based on the difference.

4. The object determination apparatus according to claim 1, wherein
the determination circuitry which, in operation, determines that the type is a pole in a case where the difference is smaller than a first threshold, and determines that the type is a pedestrian in a case where the difference is between a second threshold and a third threshold, the second threshold being larger than the first threshold, the third threshold being larger than the second threshold.

5. The object determination apparatus according to claim 4, wherein
the determination circuitry which, in operation, calculates coordinates of the object, and determines that the type is a pole in a case where the difference is smaller than the first threshold and the coordinates of the object do not vary beyond a predetermined range.

6. The object determination apparatus according to claim 4, wherein
the determination circuitry which, in operation, determines that the type is a curb in a case where the difference is between the first threshold and the second threshold.

7. An object determination apparatus, comprising:
a calculation circuitry which, in operation, calculates a difference between a time of flight of an ultrasonic wave reflected by an object and an estimated value of the time of flight obtained under an assumption that the object is a stationary object, or a difference between a distance corresponding to the time of flight and an estimated value of the distance obtained under the assumption that the object is a stationary object; and
a determination circuitry which, in operation, determines a type of the object based on the difference.

8. The object determination apparatus according to claim 7, wherein
the determination circuitry which, in operation, determines the type based on a maximum value of the difference in a plurality of transmission periods.

9. The object determination apparatus according to claim 7, wherein
the determination circuitry which, in operation, determines that the type is a pole in a case where the difference is smaller than a first threshold, and determines that the type is a pedestrian in a case where the difference is between a second threshold and a third threshold, the second threshold being larger than the first threshold, the third threshold being larger than the second threshold.

10. The object determination apparatus according to claim 9, wherein
the determination circuitry which, in operation, determines that the type is a curb in a case where the difference is between the first threshold and the second threshold.

11. An object determination method, comprising:
calculating a difference in time of flight of a plurality of ultrasonic waves reflected by an object and received by a plurality of sonar apparatuses, or a difference in distance corresponding to the time of flight; and
determining a type of the object based on the difference.

12. The object determination method according to claim 11, wherein
the type is determined based on a maximum value of the difference in a plurality of transmission periods.

13. The object determination method according to claim 12, further comprising:
causing a sonar apparatus that transmits an ultrasonic wave of the plurality of ultrasonic waves corresponding to the difference to continue transmission in a next transmission period in a case where the type is determined to be a pedestrian based on the difference.

14. The object determination method according to claim 11, wherein
the type is determined to be a pole in a case where the difference is smaller than a first threshold, and the type is determined to be a pedestrian in a case where the difference is between a second threshold and a third threshold, the second threshold being larger than the first threshold, the third threshold being larger than the second threshold.

15. The object determination method according to claim 14, wherein
coordinates of the object are calculated, and the type is determined to be a pole in a case where the difference is smaller than the first threshold and the coordinates of the object do not vary beyond a predetermined range.

16. The object determination method according to claim 14, wherein
the type is determined to be a curb in a case where the difference is between the first threshold and the second threshold.

17. An object determination method, comprising:
calculating a difference between a time of flight of an ultrasonic wave reflected by an object and an estimated value of the time of flight obtained under an assumption that the object is a stationary object, or a difference between a distance corresponding to the time of flight and an estimated value of the distance obtained under the assumption that the object is a stationary object; and
determining a type of the object based on the difference.

18. The object determination method according to claim 17, wherein
the type is determined based on a maximum value of the difference in a plurality of transmission periods.

19. The object determination method according to claim 17, wherein
the type is determined to be a pole in a case where the difference is smaller than a first threshold, and the type is determined to be a pedestrian in a case where the difference is between a second threshold and a third threshold, the second threshold being larger than the first threshold, the third threshold being larger than the second threshold.

20. The object determination method according to claim 19, wherein
the type is determined to be a curb in a case where the difference is between the first threshold and the second threshold.
